(19) United States
(12) Patent Application Publication
(10) Pub. No.: US 2023/0259330 A1
(43) Pub. Date: Aug. 17, 2023

(54) PIPELINES FOR POWER AND AREA SAVINGS AND FOR HIGHER PARALLELISM

(71) Applicant: Taiwan Semiconductor Manufacturing Company, Ltd., Hsinchu (TW)

(72) Inventors: Haruki Mori, Hsinchu (TW); Wei-Chang Zhao, Hsinchu (TW); Hidehiro Fujiwara, Hsin-chu (TW)

(21) Appl. No.: 17/743,761

(22) Filed: May 13, 2022

Related U.S. Application Data
(60) Provisional application No. 63/309,306, filed on Feb. 11, 2022.

(51) Int. Cl. G06F 7/50

(52) U.S. Cl. CPC G06F 7/50

(57) ABSTRACT

A device including: a first adder having first adder inputs and first adder outputs; a first register having first register inputs and first register outputs, the first register inputs coupled to the first adder outputs; a second register having second register inputs and second register outputs, the second register inputs coupled to the first adder outputs; and a second adder having second adder inputs and second adder outputs and configured to receive register output signals from the first register outputs and the second register outputs. Wherein, the first adder is configured to calculate a first sum of a first input value and a second input value, and the first register is configured to store the first sum, and the first adder is configured to calculate a second sum of a third input value and a fourth input value, and the second register is configured to store the second sum.

### CROSS-REFERENCE TO RELATED APPLICATIONS

This application claims the benefit of U.S. Provisional Application No. 63/309,306, filed Feb. 11, 2022, and titled “PIPELINES FOR POWER AND AREA SAVINGS AND FOR HIGHER PARALLELISM,” the disclosure of which is hereby incorporated herein by reference.

### BACKGROUND

Some memory devices include compute-in-memory (CIM) systems. The CIM systems store information in memory, such as random-access memory (RAM), of a memory device and perform calculations in the memory device, as opposed to moving data between the memory device and another device for various computational steps. In CIM systems and methods, the stored data is accessed more quickly from the memory device than from other storage devices. Also, the data is analyzed more quickly in the memory device, which enables faster reporting and decision-making in business and machine learning applications, such as in convolutional neural networks (CNNs).

CNNs, also referred to as ConvNets, are a class of artificial neural networks that specialize in processing data that has a grid-like topology, such as digital image data that includes binary representations of visual images. The digital image data includes pixels, arranged in a grid-like topology, which contain values denoting image characteristics, such as color and brightness. The CNNs are used to analyze visual images in image recognition applications and often include an adder tree in a multiply accumulate (MAC) circuit. Efforts are ongoing to improve the performance and characteristics of CIM systems and CNNs.

### BRIEF DESCRIPTION OF THE DRAWINGS

Aspects of the present disclosure are best understood from the following detailed description when read with the accompanying figures. It is noted that, in accordance with the standard practice in the industry, various features are not drawn to scale. In fact, the dimensions of the various features may be arbitrarily increased or reduced for clarity of discussion. In addition, the drawings are illustrative as examples of embodiments of the disclosure and are not intended to be limiting.

FIG. 1 is a diagram schematically illustrating a CIM device that includes an adder tree having one or more pipelines, in accordance with some embodiments.

FIG. 2 is a diagram schematically illustrating a portion of an adder tree that includes pipelining, in accordance with some embodiments.

FIG. 3 is a timing diagram schematically illustrating operation of the adder tree, in accordance with some embodiments.

FIG. 4 is a diagram schematically illustrating the operation of the adder tree during the clock cycle 0, in accordance with some embodiments.

FIG. 5 is a timing diagram schematically illustrating the operation of the adder tree during the clock cycle 0, in accordance with some embodiments.

FIG. 6 is a diagram schematically illustrating the operation of the adder tree during the clock cycle 1, in accordance with some embodiments.

FIG. 7 is a timing diagram schematically illustrating the operation of the adder tree during the clock cycle 1, in accordance with some embodiments.

FIG. 8 is a diagram schematically illustrating the operation of the adder tree during the clock cycle 2, in accordance with some embodiments.

FIG. 9 is a timing diagram schematically illustrating the operation of the adder tree during the clock cycle 2, in accordance with some embodiments.

FIG. 10 is a diagram schematically illustrating an adder tree that includes pipelining with multiple register layers or stages, including a first register layer and a second register layer, in accordance with some embodiments.

FIG. 11 is a timing diagram schematically illustrating operation of the adder tree, in accordance with some embodiments.

FIG. 12 is a diagram schematically illustrating another adder tree that includes pipelining and two register layers, including a first register layer and a second register layer, in accordance with some embodiments.

FIG. 13 is a timing diagram schematically illustrating operation of the adder tree, in accordance with some embodiments.

FIG. 14 is a diagram schematically illustrating an adder tree that includes pipelining with multiple MUX layers and multiple register layers, in accordance with some embodiments.

FIG. 15 is a timing diagram schematically illustrating operation of the adder tree, in accordance with some embodiments.

FIG. 16 is a diagram schematically illustrating an adder tree that includes pipelining and two register layers, including a first register layer and a second register layer, in accordance with some embodiments.

FIG. 17 is a timing diagram schematically illustrating operation of the adder tree, in accordance with some embodiments.

FIG. 18 is a diagram schematically illustrating an 8-input adder tree that includes pipelining and two register layers, including a first register layer and a second register layer, in accordance with some embodiments.

FIG. 19 is a timing diagram schematically illustrating operation of the adder tree, in accordance with some embodiments.

FIG. 20 is a diagram schematically illustrating an 8-input adder tree that includes pipelining with MUXs and two register layers, including a first register layer and a second register layer, in accordance with some embodiments.

FIG. 21 is a timing diagram schematically illustrating operation of the adder tree, in accordance with some embodiments.

FIG. 22 is a diagram schematically illustrating an adder tree with a stepwise pipeline architecture, in accordance with some embodiments.

FIG. 23 is a diagram schematically illustrating an adder tree including one or more plain pipelines, in accordance with some embodiments.

FIG. 24 is a diagram schematically illustrating a method of adding in an adder tree that includes one or more registers, in accordance with some embodiments.

### DETAILED DESCRIPTION

The following disclosure provides many different embodiments, or examples, for implementing different features of the provided subject matter. Specific examples of components and arrangements are described below to simplify the present disclosure. These are, of course, merely examples and are not intended to be limiting. For example, the formation of a first feature over or on a second feature in the description that follows may include embodiments in which the first and second features are formed in direct contact, and may also include embodiments in which additional features may be formed between the first and second features, such that the first and second features may not be in direct contact. In addition, the present disclosure may repeat reference numerals and/or letters in the various examples. This repetition is for the purpose of simplicity and clarity and does not in itself dictate a relationship between the various embodiments and/or configurations discussed.

Further, spatially relative terms, such as “beneath,” “below,” “lower,” “above,” “upper” and the like, may be used herein for ease of description to describe one element or feature's relationship to another element(s) or feature(s) as illustrated in the figures. The spatially relative terms are intended to encompass different orientations of the device in use or operation in addition to the orientation depicted in the figures. The apparatus may be otherwise oriented (rotated 90 degrees or at other orientations) and the spatially relative descriptors used herein may likewise be interpreted accordingly.

CNNs include at least one MAC circuit for multiplying input/output (I/O) data by CNN filter weights. Each of the MAC circuits includes an adder tree that conventionally includes many adders in many gate levels or adder levels. Thus, the adder tree consumes a large amount of power and takes up a large area in an integrated circuit. Also, propagation delay times through the adder tree are quite long.

Disclosed embodiments include adder trees that include registers in a pipeline architecture. The adder trees include one or more pipelines, such that the adder trees can have fewer adders, which reduces power consumption and the amount of area taken up by an adder tree in an integrated circuit. The adder trees with one or more pipelines also realize higher parallelism and decrease delays by decreasing the number of gate levels or adder levels and shortening critical paths in the adder tree. In some embodiments, the area overhead of pipelining is ˜18% and the delay improvement is ˜50% with the pipelines. In some embodiments, this results in a tera-operations per second (TOPS) per millimeter squared (mm2) improvement of 61% with 2 register stages and 76% with 3 register stages. In some embodiments, the adder trees with one or more pipelines are used in CIM systems. In some embodiments, the adder trees with one or more pipelines are used in CNNs. In some embodiments, the adder trees with one or more pipelines are used in MACs in CNNs.

Embodiments of the disclosure include registers connected between an m-bit full adder (FA) and an m+1-bit FA. In operation, inputs, such as 1A and 2A, are provided to the m bit FA at cycles 0, 2, and 4 and so on, and inputs, such as 1B and 2B, are provided to the m bit FA at cycles 1, 3, and 5 and so on. The sum of 1A and 2A is stored in a register A, and the sum of 1B and 2B is stored in a register B. The m+1 bit FA calculates a sum of the values stored in register A and register B at cycles 2, and 4 and so on. In some embodiments, multiplexers (MUXs) gate the inputs 1A and 1B and the inputs 1B and 2B to the m-bit FA.

In some embodiments, the adder tree includes multiple register layers or stages, such as a first layer with registers disposed between one or more m-bit FAs and one or more m+1-bit FAs, and a second layer with registers disposed between one or more m+1-bit FAs and one or more m+2-bit FAs. The registers in the first layer enable parallel operation for computing and pipelining accumulated inputs and the registers in the second layer further enable computing and pipelining accumulated values. In some embodiments, MUXs gate the inputs to the one or more m-bit FAs. In some embodiments, MUXs gate outputs from the registers in the first layer to the one or more m+1-bit FAs. In any embodiments, multiplexing multiple inputs to the FAs in the pipeline adder tree increases parallelism and reduces the number of FAs, which reduces layout area and power consumption.

Embodiments of the disclosure further include adder trees with stepwise pipelines that optimize balancing of propagation delays between stages, and embodiments of the disclosure further include adder trees with a plain pipeline architecture that is a simpler design for placing the adders and the clock (CLK) tree.

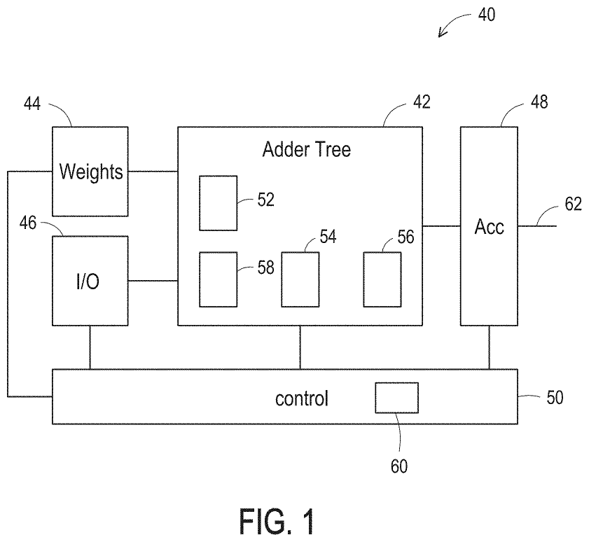

FIG. 1 is a block diagram schematically illustrating a CIM device 40 that includes an adder tree 42 having one or more pipelines, in accordance with some embodiments. The CIM device 40 and the adder tree 42 are configured to perform at least some of the functions of a CNN. However, the adder tree 42 is not limited to being in a CIM device, such as the CIM device 40, or in a CNN application. In other embodiments, the adder tree 42 can be situated in a device that is not a CIM device. Also, in other embodiments, the adder tree 42 can be used in an application that is not a CNN application.

The CIM device 40 includes the adder tree 42, a weight storage node 44, I/O circuitry 46, an accumulator 48, and a control circuit 50. The adder tree 42 is electrically coupled to each of the weight storage node 44, the I/O circuitry 46, the accumulator 48, and the control circuit 50. The control circuit 50 is electrically coupled to each of the adder tree 42, the weight storage node 44, the I/O circuitry 46, and the accumulator 48.

The weight storage node 44 stores CNN filter weights and provides the stored CNN filter weights to the adder tree 42, and the I/O circuitry 46 receives I/O data and provides the I/O data to the adder tree 42. The weight storage node 44 can be implemented with a variety of memories, including RAM and a static random-access memory (SRAM). In the SRAM, data are written to and read from an SRAM cell via one or more bit-lines upon activation of one or more access transistors in the SRAM cell by signals from one or more word-lines. In some embodiments, the CNN filter weights are 4-bit weights.

The adder tree 42 receives the CNN filter weights from the weight storage node 44 and the I/O data from the I/O circuitry 46. The adder tree 42 includes multipliers 52 that multiply the I/O data by the CNN filter weights. The adder tree 42 further includes adders 54 and registers 56 for adding output signals from the multipliers 52. In some embodiments, the multipliers 52 include logic circuits, such as 2 input NOR gates, for multiplying the I/O data by the CNN filter weights. In some embodiments, the adder tree 42 further includes MUXs 58.

The control circuit 50 is configured to control the CIM device 40. The control circuit 50 receives control signals including row and column addresses for accessing the weight storage node 44 and providing the CNN filter weights to the adder tree 42. Also, the control circuit 50 receives control signals for controlling the I/O circuitry 46 and providing the I/O data to the adder tree 42. In addition, the control circuit 50 includes a clocking circuit 60 that provides clock signals to the registers 56 in the adder tree 42 for pipelining sums and partial sums through the adder tree 42.

The accumulator 48 is electrically coupled to the adder tree 42 and configured to receive sums and/or partial sums from the adder tree 42. The accumulator 48 accumulates the sums and/or partial sums and provides accumulated summation results at an output 62.

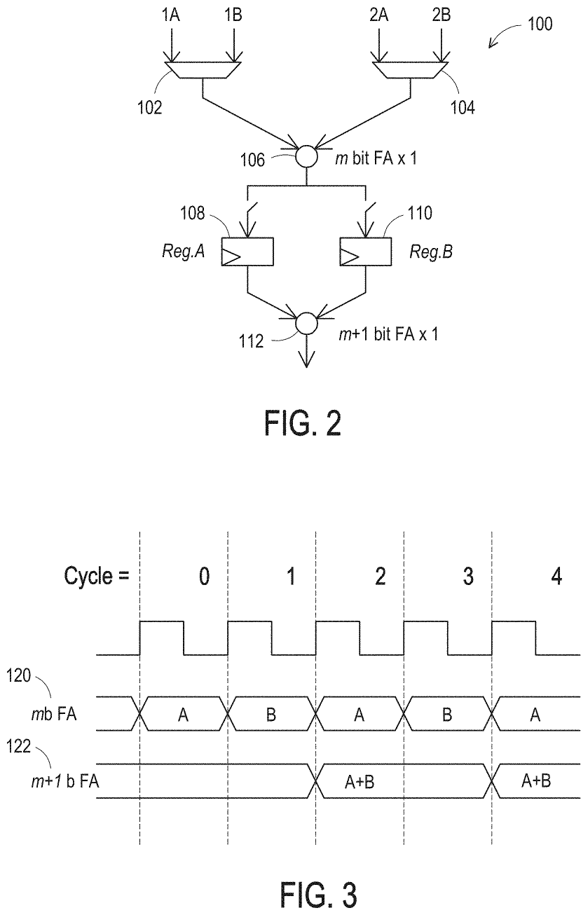

FIG. 2 is a diagram schematically illustrating a portion of an adder tree 100 that includes pipelining, in accordance with some embodiments. The adder tree 100 receives input signals 1A, 2A, 1B, and 2B and provides pipelined summation results A+B. In some embodiments, the adder tree 100 is like the adder tree 42 (shown in FIG. 1).

The adder tree 100 includes a first MUX 102 and a second MUX 104. Each of the first MUX 102 and the second MUX 104 has outputs electrically coupled to corresponding inputs of a first adder 106. The first MUX 102 has inputs that receive the input signals 1A and 1B and the second MUX 104 has inputs that receive the input signals 2A and 2B.

The adder tree 100 further includes a first register (register A) 108 and a second register (register B) 110. Each of the first register 108 and the second register 110 has inputs electrically coupled to corresponding outputs of the first adder 106, and each of the first register 108 and the second register 110 has outputs electrically coupled to corresponding inputs of a second adder 112. The outputs of the second adder 112 provide the pipelined summation results A+B.

The first adder 106 is an m bit FA configured to receive input signals of m bits from each of the first MUX 102 and the second MUX 104. The first adder 106 adds the m bit input signals from the first MUX 102 and the second MUX 104 and provides an m+1 bit summation result. The value of m is an integer that is used to keep track of the number of bits being added at different adders.

Each of the first register 108 and the second register 110 receives and stores an m+1 bit summation result from the first adder 106 and provides the m+1 bit summation result to the second adder 112.

The second adder 112 is an m+1 bit FA configured to receive input signals of m+1 bits from each of the first register 108 and the second register 110. The second adder 112 adds the input signals from the first register 108 and the second register 110 to provide an m+2 bit summation result at outputs of the second adder 112.

FIG. 3 is a timing diagram schematically illustrating operation of the adder tree 100, in accordance with some embodiments. The adder tree 100 receives clock signals for clocking the first register 108 and the second register 110. In some embodiments, the first register 108 and the second register 110 are clocked at the same time, i.e., simultaneously, by the clock signals. In some embodiments, the clock signals are provided by a clocking circuit like the clocking circuit 60 (shown in FIG. 1).

In operation, selected inputs from the first MUX 102 and the second MUX 104 are provided to the first adder 106 during different clock cycles. Input signals 1A and 2A are provided to the first adder 106 during the clock cycles 0, 2, and 4, and so on, and input signals 1B and 2B are provided to the first adder 106 during the clock cycles 1, 3, and 5, and so on.

In row 120, the first adder 106 provides a sum A of the input signals 1A and 2A during the clock cycles 0, 2, and 4, and so on, and a sum B of the input signals 1B and 2B during the clock cycles 1, 3, and 5, and so on. The sum A is stored in the first register 108 and the sum B is stored in the second register 110.

In row 122, the second adder 112 calculates a summation result A+B of the sums A and B, which are stored in the first and second registers 108 and 110, during the clock cycles 2, and 4, and so on. Thus, the summation results A+B are pipelined in the clock cycles.

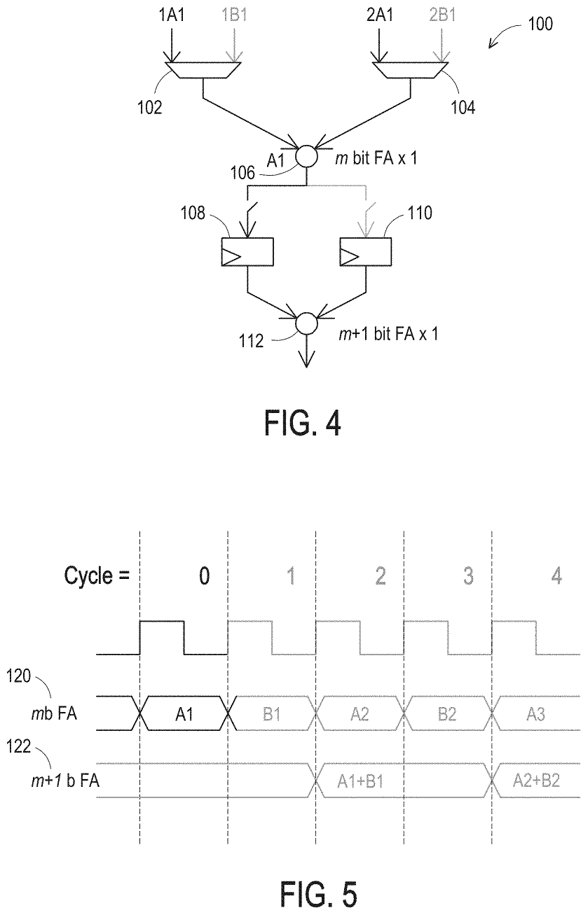

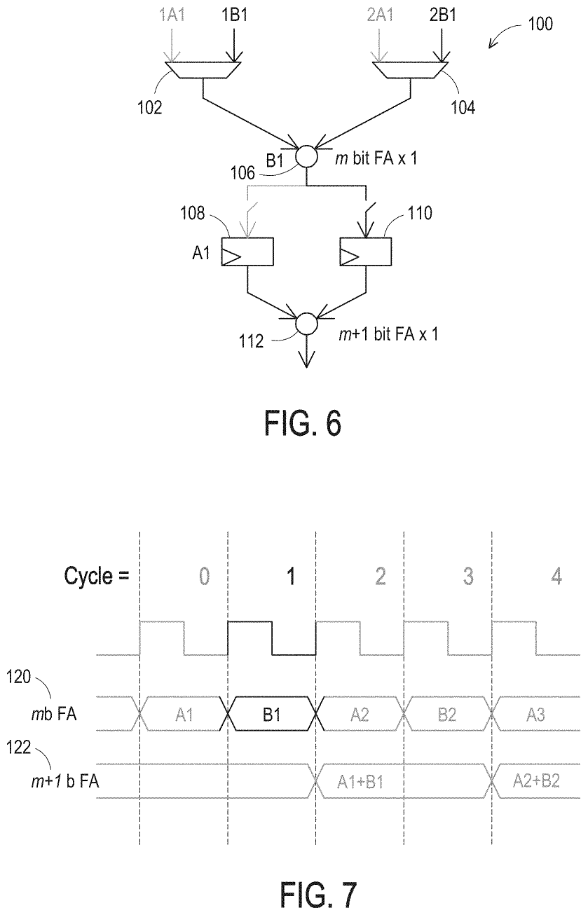

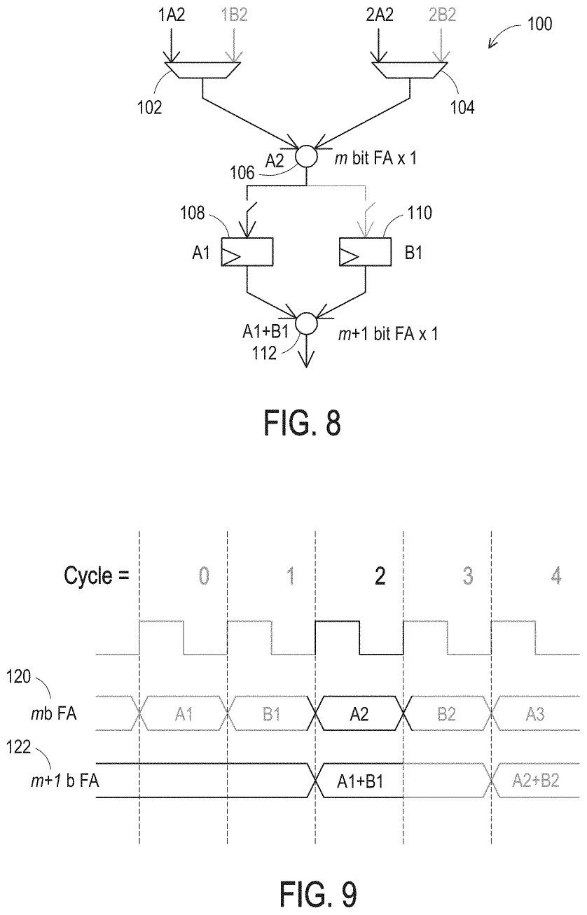

FIGS. 4-9 are diagrams schematically illustrating the operation of the adder tree 100 during different clock cycles, in accordance with some embodiments. FIGS. 4 and 5 are diagrams schematically illustrating the operation of the adder tree 100 during the clock cycle 0, FIGS. 6 and 7 are diagrams schematically illustrating the operation of the adder tree 100 during the clock cycle 1, and FIGS. 8 and 9 are diagrams schematically illustrating the operation of the adder tree 100 during the clock cycle 2, in accordance with some embodiments.

FIG. 4 is a diagram schematically illustrating the operation of the adder tree 100 during the clock cycle 0, in accordance with some embodiments, and FIG. 5 is a timing diagram schematically illustrating the operation of the adder tree 100 during the clock cycle 0, in accordance with some embodiments.

In reference to FIGS. 4 and 5, the input signals 1A1 and 2A1 are provided to the first adder 106 during the clock cycle 0. As shown in FIG. 4 and in row 120 of FIG. 5, the first adder 106 adds the input signals 1A1 and 2A1 and provides a sum A1 of the input signals 1A1 and 2A1 during the clock cycle 0.

FIG. 6 is a diagram schematically illustrating the operation of the adder tree 100 during the clock cycle 1, in accordance with some embodiments, and FIG. 7 is a timing diagram schematically illustrating the operation of the adder tree 100 during the clock cycle 1, in accordance with some embodiments.

In reference to FIGS. 6 and 7, the input signals 1B1 and 2B1 are provided to the first adder 106 during the clock cycle 1. As shown in FIG. 6 and in row 120 of FIG. 7, the first adder 106 adds the input signals 1B1 and 2B1 and provides a sum B1 of the input signals 1B1 and 2B1 during the clock cycle 1. Also, the first register 108 clocks in and stores the sum A1 during the clock cycle 1.

FIG. 8 is a diagram schematically illustrating the operation of the adder tree 100 during the clock cycle 2, in accordance with some embodiments, and FIG. 9 is a timing diagram schematically illustrating the operation of the adder tree 100 during the clock cycle 2, in accordance with some embodiments.

In reference to FIGS. 8 and 9, a second set of A input signals 1A2 and 2A2, that are (or can be) different than the input signals 1A1 and 2A1, are provided to the first adder 106 during the clock cycle 2. As shown in FIG. 8 and in row 120 of FIG. 9, the first adder 106 adds the second set of input signals 1A2 and 2A2 and provides a second sum A2 of the second set of input signals 1A2 and 2A2 during the clock cycle 2. Also, the second register 110 clocks in the sum B1 during the clock cycle 2. With the sum A1 stored in the first register 108, the second adder 112 calculates the pipeline summation result A1+B1 during the clock cycle 2, as shown in FIG. 8 and in row 122 of FIG. 9.

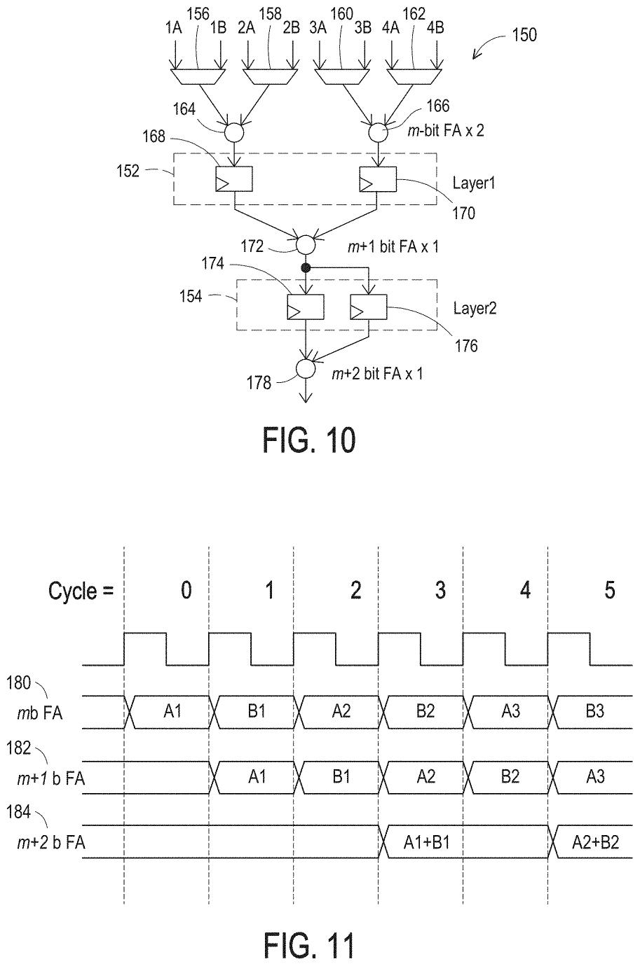

FIG. 10 is a diagram schematically illustrating an adder tree 150 that includes pipelining with multiple register layers or stages, including a first register layer (Layer1) 152 and a second register layer (Layer2) 154, in accordance with some embodiments. The adder tree 150 receives input signals 1A, 2A, 3A, 4A, 1B, 2B, 3B, and 4B and provides pipelined summation results A+B. In some embodiments, the adder tree 150 is like the adder tree 42 (shown in FIG. 1).

The adder tree 150 includes a first MUX 156, a second MUX 158, a third MUX 160, and a fourth MUX 162. Each of the first MUX 156 and the second MUX 158 has outputs electrically coupled to corresponding inputs of a first adder 164, and each of the third MUX 160 and the fourth MUX 162 has outputs electrically coupled to corresponding inputs of a second adder 166. The first MUX 156 has inputs that receive the input signals 1A and 1B, the second MUX 158 has inputs that receive the input signals 2A and 2B, the third MUX 160 has inputs that receive the input signals 3A and 3B, and the fourth MUX 162 has inputs that receive the input signals 4A and 4B. Multiplexing multiple inputs to the first and second adders 164 and 166, increases parallelism and reduces the number of adders in the adder tree 150, which reduces layout area and power consumption.

The first register layer 152 includes a first register 168 and a second register 170 disposed between the first and second adders 164 and 166 and a third adder 172. The first register 168 has inputs electrically coupled to corresponding outputs of the first adder 164, and outputs electrically coupled to corresponding inputs of the third adder 172. The second register 170 has inputs electrically coupled to corresponding outputs of the second adder 166, and outputs electrically coupled to corresponding inputs of the third adder 172. The first register 168 and the second register 170 in the first register layer 152 enable parallel operation for computing and pipelining accumulated inputs.

The second register layer 154 includes a third register 174 and a fourth register 176 disposed between the third adder 172 and a fourth adder 178. The third register 174 has inputs electrically coupled to corresponding outputs of the third adder 172, and outputs electrically coupled to corresponding inputs of the fourth adder 178. The fourth register 176 has inputs electrically coupled to corresponding outputs of the third adder 172, and outputs electrically coupled to corresponding inputs of the fourth adder 178. The third register 174 and the fourth register 176 in the second register layer 154 enable parallel operation for computing and pipelining accumulated inputs. The outputs of the fourth adder 178 provide the pipelined summation results A+B.

The first adder 164 is an m bit FA configured to receive input signals of m bits from each of the first MUX 156 and the second MUX 158. The first adder 164 adds the m bit input signals from the first MUX 156 and the second MUX 158 and provides an m+1 bit summation result to the inputs of the first register 168. Also, the second adder 166 is an m bit FA configured to receive input signals of m bits from each of the third MUX 160 and the fourth MUX 162. The second adder 166 adds the m bit input signals from the third MUX 160 and the fourth MUX 162 and provides an m+1 bit summation result to the inputs of the second register 170. The value of m is an integer that is used to keep track of the number of bits being added at different adders.

The first register 168 receives and stores the m+1 bit summation result from the first adder 164, and the second register 170 receives and stores the m+1 bit summation result from the second adder 166. Each of the first and second registers 168 and 170 provides the stored m+1 bit summation result to the third adder 172. In some embodiments, the first register 168 and the second register 170 clock in and store the m+1 bit summation results from the first adder 164 and the second adder 166 at the same time, i.e., simultaneously.

The third adder 172 is an m+1 bit FA configured to receive input signals of m+1 bits from each of the first register 168 and the second register 170. The third adder 172 adds the input signals from the first register 168 and the second register 170 and provides m+2 bit summation results at outputs of the third adder 172.

The third register 174 receives and stores a first m+2 bit summation result from the third adder 172 and provides the first m+2 bit summation result to the fourth adder 178. The fourth register 176 receives and stores a second m+2 bit summation result from the third adder 172 and provides the second m+2 bit summation result to the fourth adder 178.

The fourth adder 178 is an m+2 bit FA configured to receive input signals of m+2 bits from each of the third register 174 and the fourth register 176. The fourth adder 178 adds the input signals from the third register 174 and the fourth register 176 and provides an m+3 bit summation result at outputs of the fourth adder 178.

FIG. 11 is a timing diagram schematically illustrating operation of the adder tree 150, in accordance with some embodiments. The adder tree 150 receives clock signals for clocking the first register 168, the second register 170, the third register 174, and the fourth register 176. In some embodiments, the first register 168 and the second register 170 are clocked at the same time, i.e., simultaneously, by the clock signals. In some embodiments, the clock signals are provided by a clocking circuit like the clocking circuit 60 (shown in FIG. 1).

In operation, selected inputs from the first MUX 156 and the second MUX 158 are provide to the first adder 164, and selected inputs from the third MUX 160 and the fourth MUX 162 are provided to the second adder 166. In the present example, input signals 1A and 2A are provided to the first adder 164 and input signals 3A and 4A are provided to the second adder 166 during clock cycles 0, 2, and 4, and so on. Also, input signals 1B and 2B are provided to the first adder 164 and input signals 3B and 4B are provided to the second adder 166 during the clock cycles 1, 3, and 5, and so on.

As indicated in row 180, during clock cycle 0, the first adder 164 and the second adder 166 receive a first set of A input signals 1A1, 2A1, 3A1, and 4A1 and provide summation results A1. Also, during clock cycle 1, the first adder 164 and the second adder 166 receive a first set of B input signals 1B1, 2B1, 3B1, and 4B1 and provide summation results B1.

As indicated in row 182, the first register 168 and the second register 170 clock in and store the summation results A1 from the first adder 164 and the second adder 166, respectively, during clock cycle 1. The stored A1 results are provided to the third adder 172 during clock cycle 1 and the third adder 172 provides an m+2 bit summation result A1 to the third register 174 during clock cycle 1.

During clock cycle 2, the third register 174 clocks in and stores the m+2 bit summation result A1 and the first register 168 and the second register 170 clock in and store the summation results B1 from the first adder 164 and the second adder 166, respectively. The stored B1 results are provided to the third adder 172 during clock cycle 2 and the third adder 172 provides an m+2 bit summation result B1 to the fourth register 176 during clock cycle 2. Also, the first adder 164 and the second adder 166 receive a second set of A input signals 1A2, 2A2, 3A2, and 4A2 and provide summation results A2 to the inputs of the first register 168 and the second register 170.

As indicated in row 184, during clock cycle 3, the fourth register 176 clocks in and stores the m+2 bit summation result B1, such that the third register 174 provides the m+2 bit summation result A1 to the fourth adder 178 and the fourth register 176 provides the m+2 bit summation result B1 to the fourth adder 178. The fourth adder 178 adds the m+2 bit summation result A1 and the m+2 bit summation result B1 to provide an m+3 bit summation result A1+B1.

Also, during clock cycle 3, the first register 168 and the second register 170 clock in and store the summation results A2 from the first adder 164 and the second adder 166, respectively, and the first adder 164 and the second adder 166 receive a second set of B input signals 1B2, 2B2, 3B2, and 4B2 and provide summation results B2 to the inputs of the first register 168 and the second register 170.

During clock cycle 4, the third register 174 clocks in and stores the m+2 bit summation result A2 and the first register 168 and the second register 170 clock in and store the summation results B2 from the first adder 164 and the second adder 166, respectively. Also, the first adder 164 and the second adder 166 receive a third set of A input signals 1A3, 2A3, 3A3, and 4A3 and provide summation results A3 to the inputs of the first register 168 and the second register 170.

During clock cycle 5, the fourth register 176 clocks in and stores the m+2 bit summation result B2, such that the third register 174 provides the m+2 bit summation result A2 to the fourth adder 178 and the fourth register 176 provides the m+2 bit summation result B2 to the fourth adder 178. The fourth adder 178 adds the m+2 bit summation result A2 and the m+2 bit summation result B2 to provide an m+3 bit summation result A2+B2.

Also, during clock cycle 5, the first register 168 and the second register 170 clock in and store the summation results A3 from the first adder 164 and the second adder 166, respectively, and the first adder 164 and the second adder 166 receive a third set of B input signals 1B3, 2B3, 3B3, and 4B3 and provide summation results B3 to the inputs of the first register 168 and the second register 170. This process continues as described above to provide pipelined summation results of A1+B1, A2+B2, and so on.

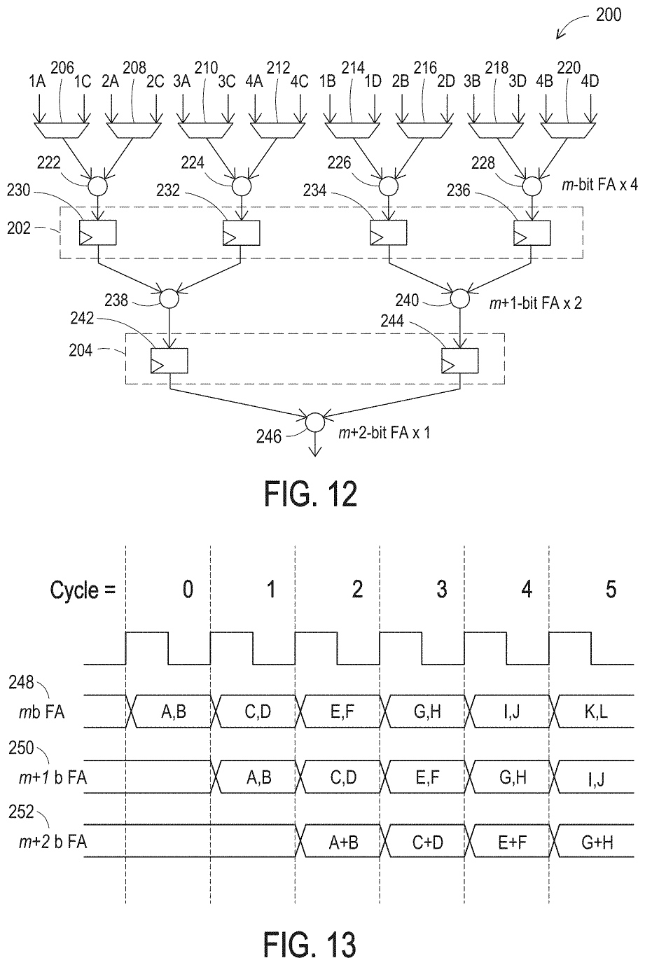

FIG. 12 is a diagram schematically illustrating another adder tree 200 that includes pipelining and two register layers, including a first register layer 202 and a second register layer 204, in accordance with some embodiments. The adder tree 200 receives four input signals in each set of inputs signals, such as 1A, 2A, 3A, 4A; 1B, 2B, 3B, 4B; 1C, 2C, 3C, 4C; and 1D, 2D, 3D, 4D. The adder tree 200 provides pipelined summation results of the input signals, such as pipelined results A+B and C+D. In some embodiments, the adder tree 200 receives four input signals in each set of more than four sets A-D, such as in each of twelve sets A-L or more. In some embodiments, the adder tree 200 is like the adder tree 42 (shown in FIG. 1).

The adder tree 200 includes a first MUX 206, a second MUX 208, a third MUX 210, a fourth MUX 212, a fifth MUX 214, a sixth MUX 216, a seventh MUX 218, and an eighth MUX 220. Each of the first MUX 206 and the second MUX 208 has outputs electrically coupled to corresponding inputs of a first adder 222, each of the third MUX 210 and the fourth MUX 212 has outputs electrically coupled to corresponding inputs of a second adder 224, each of the fifth MUX 214 and the sixth MUX 216 has outputs electrically coupled to corresponding inputs of a third adder 226, and each of the seventh MUX 218 and the eighth MUX 220 has outputs electrically coupled to corresponding inputs of a fourth adder 228. The first MUX 206 has inputs that receive the input signals 1A and 1C, the second MUX 208 has inputs that receive the input signals 2A and 2C, the third MUX 210 has inputs that receive the input signals 3A and 3C, the fourth MUX 212 has inputs that receive the input signals 4A and 4C, the fifth MUX 214 has inputs that receive the input signals 1B and 1D, the sixth MUX 216 has inputs that receive the input signals 2B and 2D, the seventh MUX 218 has inputs that receive the input signals 3B and 3D, and the eighth MUX 220 has inputs that receive the input signals 4B and 4D. Multiplexing multiple inputs to the first, second, third, and fourth adders 222, 224, 226, and 228, increases parallelism and reduces the number of adders in the adder tree 200, which reduces layout area and power consumption.

The first register layer 202 includes a first register 230, a second register 232, a third register 234, and a fourth register 236 disposed between the first, second, third, and fourth adders 222, 224, 226, and 228 and a fifth adder 238 and a sixth adder 240. The first register 230 has inputs electrically coupled to corresponding outputs of the first adder 222, and outputs electrically coupled to corresponding inputs of the fifth adder 238. The second register 232 has inputs electrically coupled to corresponding outputs of the second adder 224, and outputs electrically coupled to corresponding inputs of the fifth adder 238. The third register 234 has inputs electrically coupled to corresponding outputs of the third adder 226, and outputs electrically coupled to corresponding inputs of the sixth adder 240. The fourth register 236 has inputs electrically coupled to corresponding outputs of the fourth adder 228, and outputs electrically coupled to corresponding inputs of the sixth adder 240. The first register 230, the second register 232, the third register 234, and the fourth register 236 in the first register layer 202 enable parallel operation for computing and pipelining accumulated inputs.

The second register layer 204 includes a fifth register 242 and a sixth register 244 disposed between the fifth and sixth adders 238 and 240 and a seventh adder 246. The fifth register 242 has inputs electrically coupled to corresponding outputs of the fifth adder 238, and outputs electrically coupled to corresponding inputs of the seventh adder 246. The sixth register 244 has inputs electrically coupled to corresponding outputs of the sixth adder 240, and outputs electrically coupled to corresponding inputs of the seventh adder 246. The fifth register 242 and the sixth register 244 in the second register layer 204 enable parallel operation for computing and pipelining accumulated inputs. The outputs of the seventh adder 246 provide the pipelined summation results, such as A+B and C+D.

The first adder 222 is an m bit FA configured to receive input signals of m bits from each of the first MUX 206 and the second MUX 208. The first adder 222 adds the m bit input signals from the first MUX 206 and the second MUX 208 and provides an m+1 bit summation result to the inputs of the first register 230. The second adder 224 is an m bit FA configured to receive input signals of m bits from each of the third MUX 210 and the fourth MUX 212. The second adder 224 adds the m bit input signals from the third MUX 210 and the fourth MUX 212 and provides an m+1 bit summation result to the inputs of the second register 232.

The third adder 226 is an m bit FA configured to receive input signals of m bits from each of the fifth MUX 214 and the sixth MUX 216. The third adder 226 adds the m bit input signals from the fifth MUX 214 and the sixth MUX 216 and provides an m+1 bit summation result to the inputs of the third register 234. The fourth adder 228 is an m bit FA configured to receive input signals of m bits from each of the seventh MUX 218 and the eighth MUX 220. The fourth adder 228 adds the m bit input signals from the seventh MUX 218 and the eighth MUX 220 and provides an m+1 bit summation result to the inputs of the fourth register 236. The value of m is an integer that is used to keep track of the number of bits being added at different adders.

The first register 230 receives and stores the m+1 bit summation result from the first adder 222, the second register 232 receives and stores the m+1 bit summation result from the second adder 224, the third register 234 receives and stores the m+1 bit summation result from the third adder 226, and the fourth register 236 receives and stores the m+1 bit summation result from the fourth adder 228. Each of the first and second registers 230 and 232 provide the stored m+1 bit summation result to the fifth adder 238, and each of the third and fourth registers 234 and 236 provide the stored m+1 bit summation result to the sixth adder 240. In some embodiments, the first, second, third, and fourth registers 230, 232, 234, and 236 clock in and store the m+1 bit summation results from the first, second, third, and fourth adders 222, 224, 226, and 228 at the same time, i.e., simultaneously.

The fifth adder 238 is an m+1 bit FA configured to receive input signals of m+1 bits from each of the first register 230 and the second register 232. The fifth adder 238 adds the input signals from the first register 230 and the second register 232 and provides m+2 bit summation results at outputs of the fifth adder 238. The sixth adder 240 is an m+1 bit FA configured to receive input signals of m+1 bits from each of the third register 234 and the fourth register 236. The sixth adder 240 adds the input signals from the third register 234 and the fourth register 236 and provides m+2 bit summation results at outputs of the sixth adder 240.

The fifth register 242 receives and stores the m+2 bit summation result from the fifth adder 238 and provides the m+2 bit summation result to the seventh adder 246. The sixth register 244 receives and stores the m+2 bit summation result from the sixth adder 240 and provides the m+2 bit summation result to the seventh adder 246.

The seventh adder 246 is an m+2 bit FA configured to receive input signals of m+2 bits from each of the fifth register 242 and the sixth register 244. The seventh adder 246 adds the input signals from the fifth register 242 and the sixth register 244 and provides an m+3 bit summation result at outputs of the seventh adder 246.

FIG. 13 is a timing diagram schematically illustrating operation of the adder tree 200, in accordance with some embodiments. The adder tree 200 receives clock signals for clocking the first register 230, the second register 232, the third register 234, the fourth register 236, the fifth register 242, and the sixth register 244. In some embodiments, the first register 230, the second register 232, the third register 234, the fourth register 236, the fifth register 242, and the sixth register 244 are clocked at the same time, i.e., simultaneously, by the clock signals. In some embodiments, the first register 230, the second register 232, the third register 234, and the fourth register 236 are clocked at the same time, i.e., simultaneously, by the clock signals. In some embodiments, the fifth register 242 and the sixth register 244 are clocked at the same time, i.e., simultaneously, by the clock signals. In some embodiments, the clock signals are provided by a clocking circuit like the clocking circuit 60 (shown in FIG. 1).

In operation, selected inputs from the first MUX 206 and the second MUX 208 are provided to the first adder 222, selected inputs from the third MUX 210 and the fourth MUX 212 are provided to the second adder 224, selected inputs from the fifth MUX 214 and the sixth MUX 216 are provided to the third adder 226, and selected inputs from the seventh MUX 218 and the eighth MUX 220 are provided to the fourth adder 228.

As indicated in row 248, during clock cycle 0, the first adder 222 and the second adder 224 receive a set of A input signals 1A, 2A, 3A, and 4A and provide summation results A to the inputs of the first register 230 and the second register 232. Also, the third adder 226 and the fourth adder 228 receive a set of B input signals 1B, 2B, 3B, and 4B and provide summation results B to the inputs of the third register 234 and the fourth register 236.

Also, during clock cycle 1, the first adder 222 and the second adder 224 receive a set of C input signals 1C, 2C, 3C, and 4C and provide summation results C to the inputs of the first register 230 and the second register 232, and the third adder 226 and the fourth adder 228 receive a set of D input signals 1D, 2D, 3D, and 4D and provide summation results D to the inputs of the third register 234 and the fourth register 236.

As indicated in row 250, during clock cycle 1, the first register 230 and the second register 232 clock in and store the summation results A from the first adder 222 and the second adder 224, respectively, and the third register 234 and the fourth register 236 clock in and store the summation results B from the third adder 226 and the fourth adder 228, respectively. The stored A results are provided to the fifth adder 238 during clock cycle 1 and the fifth adder 238 provides an m+2 bit summation result A to the fifth register 242 during clock cycle 1. The stored B results are provided to the sixth adder 240 during clock cycle 1 and the sixth adder 240 provides an m+2 bit summation result B to the sixth register 244 during clock cycle 1

As indicated in row 252, during clock cycle 2, the fifth register 242 clocks in and stores the m+2 bit summation result A and the sixth register 244 clocks in and stores the m+2 bit summation result B. The m+2 bit summation results A and B are provided to the seventh adder 246 that adds the results and provides at an output of the seventh adder 246 an m+3 bit summation result A+B.

Also, during clock cycle 2, the first register 230 and the second register 232 clock in and store the summation results C from the first adder 222 and the second adder 224, respectively, and the third register 234 and the fourth register 236 clock in and store the summation results D from the third adder 226 and the fourth adder 228, respectively. The stored C results are provided to the fifth adder 238 during clock cycle 2 and the fifth adder 238 provides an m+2 bit summation result C to the fifth register 242 during clock cycle 2. Also, the stored D results are provided to the sixth adder 240 during clock cycle 2 and the sixth adder 240 provides an m+2 bit summation result D to the sixth register 244 during clock cycle 2. In addition, the first adder 222 and the second adder 224 receive a set of E input signals 1E, 2E, 3E, and 4E and provide summation results E to the inputs of the first register 230 and the second register 232, and the third adder 226 and the fourth adder 228 receive a set of F input signals 1F, 2F, 3F, and 4F and provide summation results F to the inputs of the third register 234 and the fourth register 236.

During clock cycle 3, the fifth register 242 clocks in and stores the m+2 bit summation result C and the sixth register 244 clocks in and stores the m+2 bit summation result D. The m+2 bit summation results C and D are provided to the seventh adder 246 that adds the results and provides an m+3 bit summation result C+D at an output of the seventh adder 246.

Also, during clock cycle 3, the first register 230 and the second register 232 clock in and store the summation results E from the first adder 222 and the second adder 224, respectively, and the third register 234 and the fourth register 236 clock in and store the summation results F from the third adder 226 and the fourth adder 228, respectively. The stored E results are provided to the fifth adder 238 during clock cycle 3 and the fifth adder 238 provides an m+2 bit summation result E to the fifth register 242 during clock cycle 3. Also, the stored F results are provided to the sixth adder 240 during clock cycle 3 and the sixth adder 240 provides an m+2 bit summation result F to the sixth register 244 during clock cycle 3. In addition, the first adder 222 and the second adder 224 receive a set of G input signals 1G, 2G, 3G, and 4G and provide summation results G to the inputs of the first register 230 and the second register 232, and the third adder 226 and the fourth adder 228 receive a set of H input signals 1H, 2H, 3H, and 4H and provide summation results H to the inputs of the third register 234 and the fourth register 236.

During clock cycle 4, the fifth register 242 clocks in and stores the m+2 bit summation result E and the sixth register 244 clocks in and stores the m+2 bit summation result F. The m+2 bit summation results E and F are provided to the seventh adder 246 that adds the results and provides an m+3 bit summation result E+F at an output of the seventh adder 246.

Also, during clock cycle 4, the first register 230 and the second register 232 clock in and store the summation results G from the first adder 222 and the second adder 224, respectively, and the third register 234 and the fourth register 236 clock in and store the summation results H from the third adder 226 and the fourth adder 228, respectively. The stored G results are provided to the fifth adder 238 during clock cycle 4 and the fifth adder 238 provides an m+2 bit summation result G to the fifth register 242 during clock cycle 4. Also, the stored H results are provided to the sixth adder 240 during clock cycle 4 and the sixth adder 240 provides an m+2 bit summation result H to the sixth register 244 during clock cycle 4. In addition, the first adder 222 and the second adder 224 receive a set of I input signals 1I, 2I, 3I, and 4I and provide summation results I to the inputs of the first register 230 and the second register 232, and the third adder 226 and the fourth adder 228 receive a set of J input signals 1J, 2J, 3J, and 4J and provide summation results J to the inputs of the third register 234 and the fourth register 236.

During clock cycle 5, the fifth register 242 clocks in and stores the m+2 bit summation result G and the sixth register 244 clocks in and stores the m+2 bit summation result H. The m+2 bit summation results G and H are provided to the seventh adder 246 that adds the results and provides an m+3 bit summation result G+H at an output of the seventh adder 246.

Also, during clock cycle 5, the first register 230 and the second register 232 clock in and store the summation results I from the first adder 222 and the second adder 224, respectively, and the third register 234 and the fourth register 236 clock in and store the summation results J from the third adder 226 and the fourth adder 228, respectively. The stored I results are provided to the fifth adder 238 during clock cycle 5 and the fifth adder 238 provides an m+2 bit summation result I to the fifth register 242 during clock cycle 5. Also, the stored J results are provided to the sixth adder 240 during clock cycle 5 and the sixth adder 240 provides an m+2 bit summation result J to the sixth register 244 during clock cycle 5. In addition, the first adder 222 and the second adder 224 receive a set of K input signals 1K, 2K, 3K, and 4K and provide summation results K to the inputs of the first register 230 and the second register 232, and the third adder 226 and the fourth adder 228 receive a set of L input signals 1L, 2L, 3L, and 4L and provide summation results L to the inputs of the third register 234 and the fourth register 236. This process continues as described above to provide pipelined summation results of A+B, C+D, E+F, G+H, and so on.

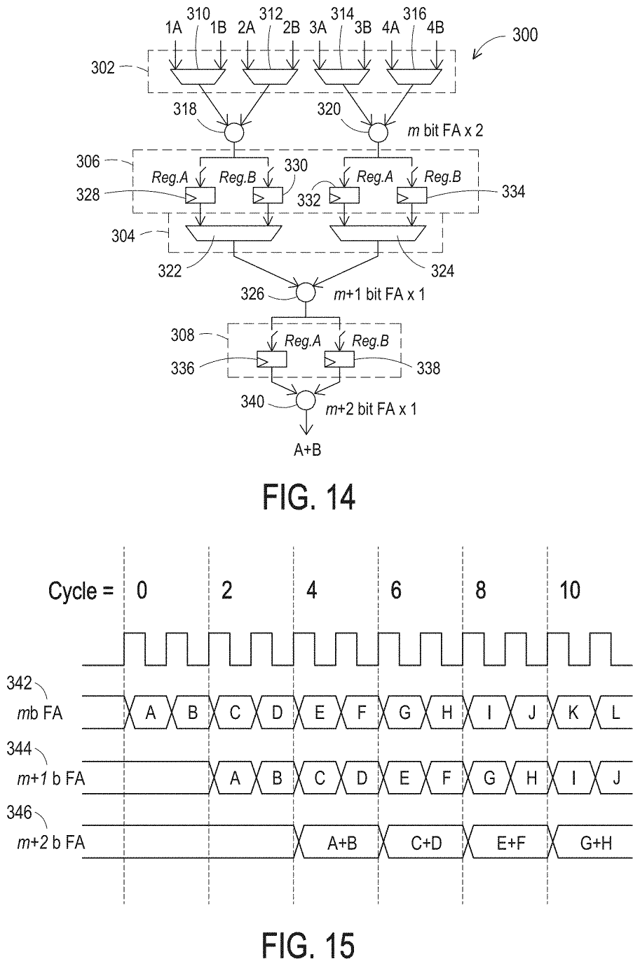

FIG. 14 is a diagram schematically illustrating an adder tree 300 that includes pipelining with multiple MUX layers and multiple register layers, in accordance with some embodiments. The adder tree 300 includes a first MUX layer 302, a second MUX layer 304, a first register layer 306, and a second register layer 308. The adder tree 300 receives four input signals in each set of inputs signals, such as 1A, 2A, 3A, and 4A and 1B, 2B, 3B, and 4B. The adder tree 300 provides pipelined summation results of the input signals, such as pipelined results A+B. In some embodiments, the adder tree 300 receives four input signals in each set of more than two sets, such as in each of twelve sets A-L or more. In some embodiments, the adder tree 300 is like the adder tree 42 (shown in FIG. 1).

The first MUX layer 302 includes a first MUX 310, a second MUX 312, a third MUX 314, and a fourth MUX 316. Each of the first MUX 310 and the second MUX 312 has outputs electrically coupled to corresponding inputs of a first adder 318, and each of the third MUX 314 and the fourth MUX 316 has outputs electrically coupled to corresponding inputs of a second adder 320. The first MUX 310 has inputs that receive the input signals 1A and 1B, the second MUX 312 has inputs that receive the input signals 2A and 2B, the third MUX 314 has inputs that receive the input signals 3A and 3B, and the fourth MUX 316 has inputs that receive the input signals 4A and 4B. Multiplexing multiple inputs to the first and second adders 318 and 320, increases parallelism and reduces the number of adders in the adder tree 300, which reduces layout area and power consumption.

The second MUX layer 304 includes a fifth MUX 322 and a sixth MUX 324. Each of the fifth MUX 322 and the sixth MUX 324 has outputs electrically coupled to corresponding inputs of a third adder 326. Multiplexing multiple inputs to the third adder 326, can further increases parallelism and reduce the number of adders in the adder tree 300, which reduces layout area and power consumption.

The first register layer 306 includes a first register (register A) 328, a second register (register B) 330, a third register (register A) 332, and a fourth register (register B) 334 disposed between the first and second adders 318 and 320 and the second MUX layer 304. The first register 328 and the second register 330 each have inputs electrically coupled to corresponding outputs of the first adder 318, and outputs electrically coupled to corresponding inputs of the fifth MUX 322. The third register 332 and the fourth register 334 each have inputs electrically coupled to corresponding outputs of the second adder 320, and outputs electrically coupled to corresponding inputs of the sixth MUX 324. The first register 328, the second register 330, the third register 332, and the fourth register 334 in the first register layer 306 enable parallel operation for computing and pipelining accumulated inputs.

The second register layer 308 includes a fifth register (register A) 336 and a sixth register (register B) 338 disposed between the third adder 326 and a fourth adder 340. The fifth register 336 has inputs electrically coupled to corresponding outputs of the third adder 326, and outputs electrically coupled to corresponding inputs of the fourth adder 340. The sixth register 338 has inputs electrically coupled to corresponding outputs of the third adder 326, and outputs electrically coupled to corresponding inputs of the fourth adder 340. The fifth register 336 and the sixth register 338 in the second register layer 308 enable parallel operation for computing and pipelining accumulated inputs. The outputs of the fourth adder 340 provide the pipelined summation results, such as A+B.

The first adder 318 is an m bit FA configured to receive input signals of m bits from each of the first MUX 310 and the second MUX 312. The first adder 318 adds the m bit input signals from the first MUX 310 and the second MUX 312 and provides an m+1 bit summation result to the inputs of the first register 328 and/or the second register 330. Also, the second adder 320 is an m bit FA configured to receive input signals of m bits from each of the third MUX 314 and the fourth MUX 316. The second adder 320 adds the m bit input signals from the third MUX 314 and the fourth MUX 316 and provides an m+1 bit summation result to the inputs of the third register 332 and/or the fourth register 334. The value of m is an integer that is used to keep track of the number of bits being added at different adders.

The first register 328 and the second register 330 provide the m+1 bit summation results to the fifth MUX 322, and the third register 332 and the fourth register 334 provide the m+1 bit summation results to the sixth MUX 324. The fifth MUX 322 and the sixth MUX 324 provide the m+1 bit summation results to the third adder 326.

The third adder 326 is an m+1 bit FA configured to receive input signals of m+1 bits from each of the fifth MUX 322 and the sixth MUX 324. The third adder 326 adds the input signals from the fifth MUX 322 and the sixth MUX 324 and provides m+2 bit summation results at outputs of the third adder 326 to the fifth register 336 and/or the sixth register 338.

The fifth register 336 receives and stores a first m+2 bit summation result from the third adder 326 and provides the first m+2 bit summation result to the fourth adder 340. The sixth register 338 receives and stores a second m+2 bit summation result from the third adder 326 and provides the second m+2 bit summation result to the fourth adder 340.

The fourth adder 340 is an m+2 bit FA configured to receive input signals of m+2 bits from each of the fifth register 336 and the sixth register 338. The fourth adder 340 adds the input signals from the fifth register 336 and the sixth register 338 and provides an m+3 bit summation result at outputs of the fourth adder 340.

In operation, during a first clock cycle 0, the first MUX 310 and the second MUX 312 provide inputs 1A and 2A to the first adder 318, and the third MUX 314 and the fourth MUX 316 provide inputs 3A and 4A to the second adder 320. The first adder 318 provides an m+1 bit summation result A to the first register 328, and the second adder 320 provides an m+1 bit summation result A to the third register 332.

During a second clock cycle 1, the first register 328 and the third register 332 clock in and store the m+1 bit summation results A and provide these m+1 bit summation results A to the fifth MUX 322 and the sixth MUX 324, respectively. Also, during the second clock cycle 1, the first MUX 310 and the second MUX 312 provide inputs 1B and 2B to the first adder 318 and the third MUX-314 and the fourth MUX 316 provide inputs 3B and 4B to the second adder 320. The first adder 318 provides an m+1 bit summation result B to the second register 330, and the second adder 320 provides an m+1 bit summation result B to the fourth register 334.

During a third clock cycle 2, the fifth MUX 322 and the sixth MUX 324 provide the m+1 bit summation results A to the third adder 326, which sums the m+1 bit summation results A and provides an m+2 bit summation result A to the fifth register 336. Also, the second register 330 and the fourth register 334 clock in and store the m+1 bit summation results B and provide the m+1 bit summation results B to the fifth MUX 322 and the sixth MUX 324. In addition, during the third clock cycle 2, the first MUX 310 and the second MUX 312 can provide other inputs to the first adder 318, and the third MUX 314 and the fourth MUX 316 can provide other inputs to the second adder 320, such that the first adder 318 provides an m+1 bit summation result to the first register 328, and the second adder 320 provides an m+1 bit summation result to the third register 332.

During a fourth clock cycle 3, the fifth register 336 clocks in and stores the m+2 bit summation result A, and the fifth MUX 322 and the sixth MUX 324 provide the m+1 bit summation results B to the third adder 326, which sums the m+1 bit summation results B and provides an m+2 bit summation result B to the sixth register 338.

During a fifth clock cycle 4, the sixth register 338 clocks in and stores the m+2 bit summation result B, and the fourth adder 340 adds the m+2 bit summation result A and the m+2 bit summation result B and provides an m+3 bit summation result A+B.

FIG. 15 is a timing diagram schematically illustrating operation of the adder tree 300, in accordance with some embodiments. The adder tree 300 receives clock signals for clocking the first register 328, the second register 330, the third register 332, the fourth register 334, the fifth register 336, and the sixth register 338. In some embodiments, the first register 328, the second register 330, the third register 332, the fourth register 334, the fifth register 336, and the sixth register 338 are clocked at the same time, i.e., simultaneously, by the clock signals. In some embodiments, the first register 328, the second register 330, the third register 332, and the fourth register 334 are clocked at the same time, i.e., simultaneously, by the clock signals. In some embodiments, the fifth register 336 and the sixth register 338 are clocked at the same time, i.e., simultaneously, by the clock signals. In some embodiments, the clock signals are provided by a clocking circuit like the clocking circuit 60 (shown in FIG. 1).

In operation, selected inputs from the first MUX 310 and the second MUX 312 are provided to the first adder 318, and selected inputs from the third MUX 314 and the fourth MUX 316 are provided to the second adder 320. In this example, four-input sets of A, C, E, G, I, and K are provided to the 1A, 2A, 3A, and 4A inputs, and four-input sets of B, D, F, H, J, and L are provided to the 1B, 2B, 3B, and 4B inputs.

As indicated in row 342, during clock cycle 0, the first MUX 310 and the second MUX 312 provide inputs 1A and 2A to the first adder 318, and the third MUX 314 and the fourth MUX 316 provide inputs 3A and 4A to the second adder 320. The first adder 318 provides an m+1 bit summation result A to the first register 328, and the second adder 320 provides an m+1 bit summation result A to the third register 332.

During clock cycle 1, the first register 328 and the third register 332 clock in and store the m+1 bit summation results A and provide these m+1 bit summation results A to the fifth MUX 322 and the sixth MUX 324, respectively (not shown in FIG. 15). Also, during clock cycle 1, the first MUX 310 and the second MUX 312 provide inputs 1B and 2B to the first adder 318 and the third MUX 314 and the fourth MUX 316 provide inputs 3B and 4B to the second adder 320. The first adder 318 provides an m+1 bit summation result B to the second register 330, and the second adder 320 provides an m+1 bit summation result B to the fourth register 334.

During clock cycle 2, as indicated in row 344, the fifth MUX 322 and the sixth MUX 324 provide the m+1 bit summation results A to the third adder 326, which sums the m+1 bit summation results A and provides an m+2 bit summation result A to the fifth register 336. Also, the second register 330 and the fourth register 334 clock in and store the m+1 bit summation results B and provide the m+1 bit summation results B to the fifth MUX 322 and the sixth MUX 324 (not shown in FIG. 15). In addition, during clock cycle 2, the first MUX 310 and the second MUX 312 provide inputs 1C and 2C to the first adder 318 and the third MUX 314 and the fourth MUX 316 provide inputs 3C and 4C to the second adder 320. The first adder 318 provides an m+1 bit summation result C to the first register 328, and the second adder 320 provides an m+1 bit summation result C to the third register 332.

During clock cycle 3, the fifth register 336 clocks in and stores the m+2 bit summation result A and, as indicated in row 344, the fifth MUX 322 and the sixth MUX 324 provide the m+1 bit summation results B to the third adder 326, which sums the m+1 bit summation results B and provides an m+2 bit summation result B to the sixth register 338. Also, the first register 328 and the third register 332 clock in and store the m+1 bit summation results C and provide the m+1 bit summation results C to the fifth MUX 322 and the sixth MUX 324. In addition, during clock cycle 3, as indicated in row 342, the first MUX 310 and the second MUX 312 provide inputs 1D and 2D to the first adder 318 and the third MUX 314 and the fourth MUX 316 provide inputs 3D and 4D to the second adder 320. The first adder 318 provides an m+1 bit summation result D to the second register 330, and the second adder 320 provides an m+1 bit summation result D to the fourth register 334.

During clock cycle 4, as indicated in row 346, the sixth register 338 clocks in and stores the m+2 bit summation result B. The fourth adder 340 adds the m+2 bit summation result A and the m+2 bit summation result B and provides an m+3 bit summation result A+B. Also, as indicated in row 344, the fifth MUX 322 and the sixth MUX 324 provide the m+1 bit summation results C to the third adder 326, which sums the m+1 bit summation results C and provides an m+2 bit summation result C to the fifth register 336, and the second register 330 and the fourth register 334 clock in and store the m+1 bit summation results D and provide the m+1 bit summation results D to the fifth MUX 322 and the sixth MUX 324 (not shown in FIG. 15). In addition, during clock cycle 4, the first MUX 310 and the second MUX 312 provide inputs 1E and 2E to the first adder 318 and the third MUX 314 and the fourth MUX 316 provide inputs 3E and 4E to the second adder 320. The first adder 318 provides an m+1 bit summation result E to the first register 328, and the second adder 320 provides an m+1 bit summation result E to the third register 332.

During clock cycle 5, the fifth register 336 clocks in and stores the m+2 bit summation result C and, as indicated in row 344, the fifth MUX 322 and the sixth MUX 324 provide the m+1 bit summation results D to the third adder 326, which sums the m+1 bit summation results D and provides an m+2 bit summation result D to the sixth register 338. Also, the first register 328 and the third register 332 clock in and store the m+1 bit summation results E and provide the m+1 bit summation results E to the fifth MUX 322 and the sixth MUX 324 (not shown in FIG. 15). In addition, during clock cycle 5, as indicated in row 342, the first MUX 310 and the second MUX 312 provide inputs 1F and 2F to the first adder 318 and the third MUX 314 and the fourth MUX 316 provide inputs 3F and 4F to the second adder 320. The first adder 318 provides an m+1 bit summation result F to the second register 330, and the second adder 320 provides an m+1 bit summation result F to the fourth register 334.

During clock cycle 6, as indicated in row 346, the sixth register 338 clocks in and stores the m+2 bit summation result D, and the fourth adder 340 adds the m+2 bit summation result C and the m+2 bit summation result D and provides an m+3 bit summation result C+D. Also, as indicated in row 344, the fifth MUX 322 and the sixth MUX 324 provide the m+1 bit summation results E to the third adder 326, which sums the m+1 bit summation results E and provides an m+2 bit summation result E to the fifth register 336, and the second register 330 and the fourth register 334 clock in and store the m+1 bit summation results F and provide the m+1 bit summation results F to the fifth MUX 322 and the sixth MUX 324 (not shown in FIG. 15). In addition, during clock cycle 6, the first MUX 310 and the second MUX 312 provide inputs 1G and 2G to the first adder 318 and the third MUX 314 and the fourth MUX 316 provide inputs 3G and 4G to the second adder 320. The first adder 318 provides an m+1 bit summation result G to the first register 328, and the second adder 320 provides an m+1 bit summation result G to the third register 332.

During clock cycle 7, the fifth register 336 clocks in and stores the m+2 bit summation result E and, as indicated in row 344, the fifth MUX 322 and the sixth MUX 324 provide the m+1 bit summation results F to the third adder 326, which sums the m+1 bit summation results F and provides an m+2 bit summation result F to the sixth register 338. Also, the first register 328 and the third register 332 clock in and store the m+1 bit summation results G and provide the m+1 bit summation results G to the fifth MUX 322 and the sixth MUX 324 (not shown in FIG. 15). In addition, during clock cycle 7, as indicated in row 342, the first MUX 310 and the second MUX 312 provide inputs 1H and 2H to the first adder 318 and the third MUX 314 and the fourth MUX 316 provide inputs 3H and 4H to the second adder 320. The first adder 318 provides an m+1 bit summation result H to the second register 330, and the second adder 320 provides an m+1 bit summation result H to the fourth register 334.

During clock cycle 8, as indicated in row 346, the sixth register 338 clocks in and stores the m+2 bit summation result F. The fourth adder 340 adds the m+2 bit summation result E and the m+2 bit summation result F and provides an m+3 bit summation result E+F. Also, as indicated in row 344, the fifth MUX 322 and the sixth MUX 324 provide the m+1 bit summation results G to the third adder 326, which sums the m+1 bit summation results G and provides an m+2 bit summation result G to the fifth register 336, and the second register 330 and the fourth register 334 clock in and store the m+1 bit summation results H and provide the m+1 bit summation results H to the fifth MUX 322 and the sixth MUX 324 (not shown in FIG. 15). In addition, during clock cycle 8, the first MUX 310 and the second MUX 312 provide inputs 1I and 2I to the first adder 318 and the third MUX 314 and the fourth MUX 316 provide inputs 3I and 4I to the second adder 320. The first adder 318 provides an m+1 bit summation result I to the first register 328, and the second adder 320 provides an m+1 bit summation result I to the third register 332.

During clock cycle 9, the fifth register 336 clocks in and stores the m+2 bit summation result G and, as indicated in row 344, the fifth MUX 322 and the sixth MUX 324 provide the m+1 bit summation results H to the third adder 326, which sums the m+1 bit summation results H and provides an m+2 bit summation result H to the sixth register 338. Also, the first register 328 and the third register 332 clock in and store the m+1 bit summation results I and provide the m+1 bit summation results I to the fifth MUX 322 and the sixth MUX 324 (not shown in FIG. 15). In addition, during clock cycle 9, as indicated in row 342, the first MUX 310 and the second MUX 312 provide inputs 1J and 2J to the first adder 318 and the third MUX 314 and the fourth MUX 316 provide inputs 3J and 4J to the second adder 320. The first adder 318 provides an m+1 bit summation result J to the second register 330, and the second adder 320 provides an m+1 bit summation result J to the fourth register 334.

During clock cycle 10, as indicated in row 346, the sixth register 338 clocks in and stores the m+2 bit summation result H. The fourth adder 340 adds the m+2 bit summation result G and the m+2 bit summation result H and provides an m+3 bit summation result G+H. Also, as indicated in row 344, the fifth MUX 322 and the sixth MUX 324 provide the m+1 bit summation results I to the third adder 326, which sums the m+1 bit summation results I and provides an m+2 bit summation result I to the fifth register 336, and the second register 330 and the fourth register 334 clock in and store the m+1 bit summation results J and provide the m+1 bit summation results J to the fifth MUX 322 and the sixth MUX 324 (not shown in FIG. 15). In addition, during clock cycle 10, the first MUX 310 and the second MUX 312 provide inputs 1K and 2K to the first adder 318 and the third MUX 314 and the fourth MUX 316 provide inputs 3K and 4K to the second adder 320. The first adder 318 provides an m+1 bit summation result K to the first register 328, and the second adder 320 provides an m+1 bit summation result K to the third register 332.

During clock cycle 11, the fifth register 336 clocks in and stores the m+2 bit summation result I and, as indicated in row 344, the fifth MUX 322 and the sixth MUX 324 provide the m+1 bit summation results J to the third adder 326, which sums the m+1 bit summation results J and provides an m+2 bit summation result J to the sixth register 338. Also, the first register 328 and the third register 332 clock in and store the m+1 bit summation results K and provide the m+1 bit summation results K to the fifth MUX 322 and the sixth MUX 324 (not shown in FIG. 15). In addition, during clock cycle 11, as indicated in row 342, the first MUX 310 and the second MUX 312 provide inputs 1L and 2L to the first adder 318 and the third MUX 314 and the fourth MUX 316 provide inputs 3L and 4L to the second adder 320. The first adder 318 provides an m+1 bit summation result L to the second register 330, and the second adder 320 provides an m+1 bit summation result L to the fourth register 334. This process continues as described above to provide pipelined summation results, such as A+B, C+D, E+F, and G+H, and so on.

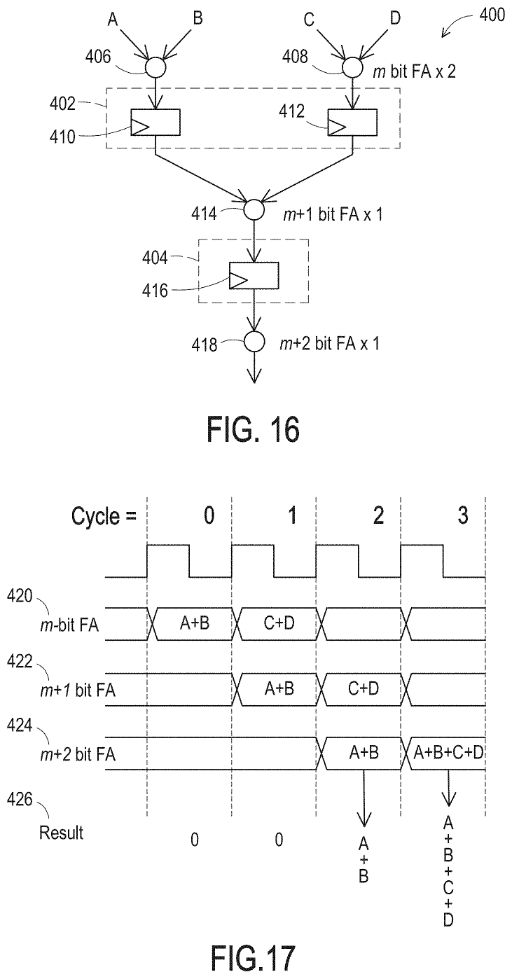

FIG. 16 is a diagram schematically illustrating an adder tree 400 that includes pipelining and two register layers, including a first register layer 402 and a second register layer 404, in accordance with some embodiments. The adder tree 400 receives sets of input signals A, B, C, and D, where each set of input signals A, B, C, and D includes m-bits. The adder tree 400 provides pipelined summation results of the sets of input signals A, B, C, and D, such as pipelined summation results A+B and A+B+C+D. In some embodiments, the adder tree 400 is like the adder tree 42 (shown in FIG. 1).

The adder tree 400 includes a first adder 406 and a second adder 408. The first adder 406 receives input signals A and B and the second adder 408 receives input signals C and D. In some embodiments, the input signals A and B are multiplexed to the first adder 406. In some embodiments the input signals C and D are multiplexed to the second adder 408.

The first register layer 402 includes a first register 410 and a second register 412 disposed between the first and second adders 406 and 408 and a third adder 414. The first register 410 has inputs electrically coupled to corresponding outputs of the first adder 406, and outputs electrically coupled to corresponding inputs of the third adder 414. The second register 412 has inputs electrically coupled to corresponding outputs of the second adder 408, and outputs electrically coupled to corresponding inputs of the third adder 414. The first register 410 and the second register 412 enable parallel operation for computing and pipelining accumulated inputs.

The second register layer 404 includes a third register 416 that has inputs electrically coupled to corresponding outputs of the third adder 414, and outputs electrically coupled to corresponding inputs of a fourth adder 418. The outputs of the third register 416 provide pipelined m+2 bit summation results, such as A+B and A+B+C+D, to the fourth adder 418.

The first adder 406 is an m bit FA configured to receive input signals of m bits from each set of input signals A and B. The first adder 406 adds the m bit input signals A and B and provides an m+1 bit summation result to the inputs of the first register 410. The second adder 408 is an m bit FA configured to receive input signals of m bits from each set of input signals C and D. The second adder 408 adds the m bit input signals C and D and provides an m+1 bit summation result to the inputs of the second register 412. The value of m is an integer that is used to keep track of the number of bits being added at different adders. In some embodiments, the input signals A and B are provided in a first clock cycle and the input signals C and D are provided in a second clock cycle.

The first register 410 receives and stores the m+1 bit summation result from the first adder 406, and the second register 412 receives and stores the m+1 bit summation result from the second adder 408. Each of the first and second registers 410 and 412 provide the stored m+1 bit summation result to the third adder 414. In some embodiments, the first and second registers 410 and 412 are clocked at the same time, i.e., simultaneously. In some embodiments, the first register 410 clocks in and stores the m+1 bit summation result from the first adder 406 in the second clock cycle and the second register 412 clocks in and stores the m+1 bit summation result from the second adder 408 in a third clock cycle.

The third adder 414 is an m+1 bit FA configured to receive input signals of m+1 bits from each of the first register 410 and the second register 412. The third adder 414 adds the input signals from the first register 410 and the second register 412 and provides an m+2 bit summation result to the third register 416.

The third register 416 receives and stores the m+2 bit summation result from the third adder 414 and provides the m+2 bit summation result to the fourth adder 418 for further processing. In some embodiments, the fourth adder 418 is an m+2 bit FA configured to receive input signals of m+2 bits from the third register 416 and from at least one other register (not shown in FIG. 16).

FIG. 17 is a timing diagram schematically illustrating operation of the adder tree 400, in accordance with some embodiments. The adder tree 400 receives clock signals for clocking the first register 410, the second register 412, and the third register 416. In some embodiments, the first register 410 and the second register 412 are clocked at the same time, i.e., simultaneously, by the clock signals. In some embodiments, the first register 410, the second register 412, and the third register 416 are clocked at the same time, i.e., simultaneously, by the clock signals. In some embodiments, the clock signals are provided by a clocking circuit like the clocking circuit 60 (shown in FIG. 1).

In operation, during clock cycle 0, the first adder 406 receives a set of input signals A and a set of input signals B. As indicated in row 420, the first adder 406 adds the input signals A and B and provides an m+1 bit summation result A+B to the first register 410.

During clock cycle 1, as indicated in row 422, the first register 410 clocks in and stores the m+1 bit summation result A+B from the first adder 406. The stored m+1 bit summation result A+B is provided to the third adder 414 and the third adder 414 provides the m+2 bit summation result A+B to the third register 416 during clock cycle 1. Also, the second adder 408 receives a set of input signals C and a set of input signals D and adds the input signals C and D to provide an m+1 bit summation result C+D to the second register 412 during clock cycle 1.

As indicated in rows 424 and 426, during clock cycle 2, the third register 416 clocks in and stores the m+2 bit summation result A+B and provides the m+2 bit summation result A+B to the fourth adder 418. Also, the second register 412 clocks in and stores the m+1 bit summation result C+D. The third adder 414 sums the m+1 bit summation result A+B that is in the first register 410 and the m+1 bit summation result C+D that is in the second register 412 and provides an m+2 bit summation result A+B+C+D to the third register 416.

During clock cycle 3, the third register 416 clocks in and stores the m+2 bit summation result A+B+C+D and provides the m+2 bit summation result A+B+C+D to the fourth adder 418.

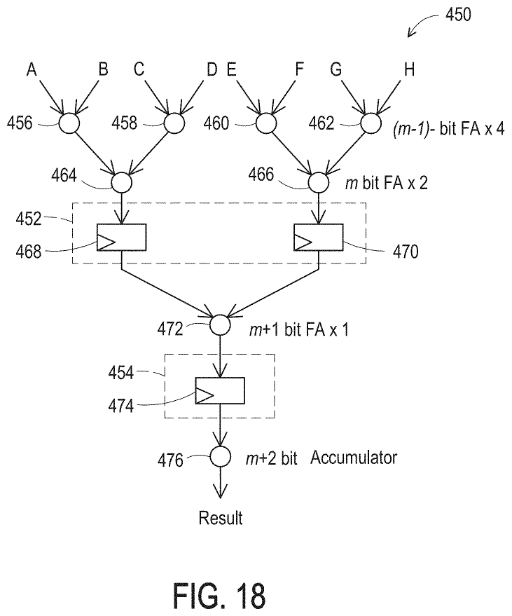

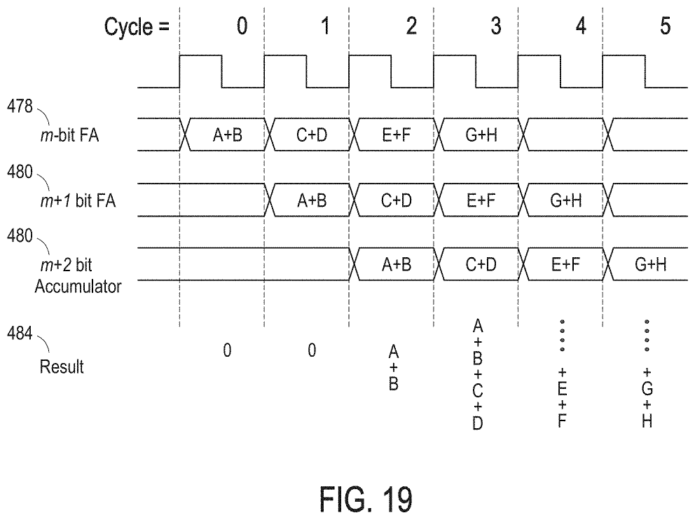

FIG. 18 is a diagram schematically illustrating an 8-input adder tree 450 that includes pipelining and two register layers, including a first register layer 452 and a second register layer 454, in accordance with some embodiments. The adder tree 450 receives input signal sets A, B, C, D, E, F, G, and H, where each of the input signal sets A, B, C, D, E, F, G, and H includes m−1 bits. The adder tree 450 provides pipelined summation results of the input signal sets A, B, C, D, E, F, G, and H, such as pipelined summation results A+B, C+D, E+F, and G+H and accumulated results A+B, A+B+C+D, A+B+C+D+E+F, and A+B+C+D+E+F+G+H. In some embodiments, the adder tree 450 is like the adder tree 42 (shown in FIG. 1).

The adder tree 450 includes a first adder 456, a second adder 458, a third adder 460, and a fourth adder 462. The first adder 456 receives input signals A and B, the second adder 458 receives input signals C and D, the third adder 460 receives input signals E and F, and the fourth adder 462 receives input signals G and H. In some embodiments, the input signals A and B are multiplexed to the first adder 456. In some embodiments the input signals C and D are multiplexed to the second adder 458. In some embodiments, the input signals E and F are multiplexed to the third adder 460. In some embodiments the input signals G and H are multiplexed to the fourth adder 462.

The adder tree 450 further includes a fifth adder 464 and a sixth adder 466. The fifth adder 464 has inputs electrically coupled to corresponding outputs from each of the first adder 456 and the second adder 458. The sixth adder 466 has inputs electrically coupled to corresponding outputs from each of the third adder 460 and the fourth adder 462.

The first register layer 452 includes a first register 468 and a second register 470 disposed between the fifth and sixth adders 464 and 466 and a seventh adder 472. The first register 468 has inputs electrically coupled to corresponding outputs of the fifth adder 464, and outputs electrically coupled to corresponding inputs of the seventh adder 472. The second register 470 has inputs electrically coupled to corresponding outputs of the sixth adder 466, and outputs electrically coupled to corresponding inputs of the seventh adder 472. The first register 468 and the second register 470 enable parallel operation for computing and pipelining accumulated inputs.

The second register layer 454 includes a third register 474 that has inputs electrically coupled to corresponding outputs of the seventh adder 472, and outputs electrically coupled to corresponding inputs of an accumulator 476. The outputs of the third register 474 provide pipelined m+2 bit summation results, such as A+B, C+D, E+F, and G+H to the accumulator 476. The accumulator 476 provides accumulated results A+B, A+B+C+D, A+B+C+D+E+F, and A+B+C+D+E+F+G+H.

The first adder 456 is an m−1 bit FA configured to receive input signals of m−1 bits from each of the input signal sets A and B. The first adder 456 adds the m−1 bit input signal sets A and B and provides an m bit summation result to the inputs of the fifth adder 464. The second adder 458 is an m−1 bit FA configured to receive input signals of m−1 bits from each of the input signal sets C and D. The second adder 458 adds the m−1 bit input signal sets C and D and provides an m bit summation result to the inputs of the fifth adder 464. The third adder 460 is an m−1 bit FA configured to receive input signals of m−1 bits from each of the input signal sets E and F. The third adder 460 adds the m−1 bit input signal sets E and F and provides an m bit summation result to the inputs of the sixth adder 466. The fourth adder 462 is an m−1 bit FA configured to receive input signals of m−1 bits from each of the input signal sets G and H. The fourth adder 462 adds the m−1 bit input signal sets G and H and provides an m bit summation result to the inputs of the sixth adder 466. The value of m is an integer that is used to keep track of the number of bits being added at different adders. In some embodiments, the input signals A and B are provided in a first clock cycle, the input signals C and D are provided in a second clock cycle, the input signals E and F are provided in a third clock cycle, and the input signals G and H are provided in a fourth clock cycle.

The fifth adder 464 is an m bit FA configured to receive input signals of m bits from each of the first adder 456 and the second adder 458. The fifth adder 464 provides an m+1 bit summation result to the inputs of the first register 468. The sixth adder 466 is an m bit FA configured to receive input signals of m bits from each of the third adder 460 and the fourth adder 462. The sixth adder 466 provides an m+1 bit summation result to the inputs of the second register 470.

The first register 468 receives and stores the m+1 bit summation result from the fifth adder 464 and provides the stored m+1 bit summation result to the seventh adder 472. The second register 470 receives and stores the m+1 bit summation result from the sixth adder 466 and provides the stored m+1 bit summation result to the seventh adder 472. In some embodiments, the first and second registers 468 and 470 are clocked at the same time, i.e., simultaneously. In some embodiments, the first register 468 clocks in and stores the m+1 bit summation result from the fifth adder 464 in the second and third clock cycles and the second register 470 clocks in and stores the m+1 bit summation result from the sixth adder 466 in the third and fourth clock cycles.

The seventh adder 472 is an m+1 bit FA configured to receive input signals of m+1 bits from each of the first register 468 and the second register 470. The seventh adder 472 provides an m+2 bit summation result to the third register 474.

The third register 474 receives and stores the m+2 bit summation result from the seventh adder 472 and provides the m+2 bit summation result to the accumulator 476, which is an m+2 bit accumulator 476. The accumulator 476 accumulates the results and provides accumulated results A+B, A+B+C+D, A+B+C+D+E+F, and A+B+C+D+E+F+G+H.

FIG. 19 is a timing diagram schematically illustrating operation of the adder tree 450, in accordance with some embodiments. The adder tree 450 receives clock signals for clocking the first register 468, the second register 470, and the third register 474. In some embodiments, the first register 468 and the second register 470 are clocked at the same time, i.e., simultaneously, by the clock signals. In some embodiments, the first register 468, the second register 470, and the third register 474 are clocked at the same time, i.e., simultaneously, by the clock signals. In some embodiments, the clock signals are provided by a clocking circuit like the clocking circuit 60 (shown in FIG. 1).

In operation, during clock cycle 0, the first adder 456 receives input signal set A and input signal set B. As indicated in row 478, the first adder 456 adds the input signal sets A and B and provides an m bit summation result A+B to the fifth adder 464, which provides an m+1 bit summation result A+B to the first register 468.

During clock cycle 1, as indicated in row 480, the first register 468 clocks in and stores the m+1 bit summation result A+B from the fifth adder 464. The stored m+1 bit summation result A+B is provided to the seventh adder 472 that provides an m+2 bit summation result A+B to the third register 474 during clock cycle 1. Also, the second adder 458 receives input signal set C and input signal set D and adds the input signal sets C and D to provide an m bit summation result C+D to the fifth adder 464, which provides an m+1 bit summation result C+D to the first register 468.

As indicated in rows 482 and 484, during clock cycle 2, the third register 474 clocks in and stores the m+2 bit summation result A+B and provides the m+2 bit summation result A+B to the accumulator 476. The accumulator 476 provides an accumulated result A+B. As indicated in row 480, the first register 468 clocks in and stores the m+1 bit summation result C+D from the fifth adder 464. The stored m+1 bit summation result C+D is provided to the seventh adder 472 that provides an m+2 bit summation result C+D to the third register 474 during clock cycle 2. Also, the third adder 460 receives input signal set E and input signal set F and adds the input signal sets E and F to provide an m bit summation result E+F to the sixth adder 466, which provides an m+1 bit summation result E+F to the second register 470.

As indicated in rows 482 and 484, during clock cycle 3, the third register 474 clocks in and stores the m+2 bit summation result C+D and provides the m+2 bit summation result C+D to the accumulator 476. The accumulator 476 provides an accumulated result A+B+C+D. As indicated in row 480, the second register 470 clocks in and stores the m+1 bit summation result E+F from the sixth adder 466. The stored m+1 bit summation result E+F is provided to the seventh adder 472 that provides an m+2 bit summation result E+F to the third register 474 during clock cycle 3. Also, the fourth adder 462 receives input signal set G and input signal set H and adds the input signal sets G and H to provide an m bit summation result G+H to the sixth adder 466, which provides an m+1 bit summation result G+H to the second register 470.

As indicated in rows 482 and 484, during clock cycle 4, the third register 474 clocks in and stores the m+2 bit summation result E+F and provides the m+2 bit summation result E+F to the accumulator 476. The accumulator 476 provides an accumulated result A+B+C+D+E+F. As indicated in row 480, the second register 470 clocks in and stores the m+1 bit summation result G+H from the sixth adder 466. The stored m+1 bit summation result G+H is provided to the seventh adder 472 that provides an m+2 bit summation result G+H to the third register 474 during clock cycle 4.

As indicated in rows 482 and 484, during clock cycle 5, the third register 474 clocks in and stores the m+2 bit summation result G+H and provides the m+2 bit summation result G+H to the accumulator 476. The accumulator 476 provides an accumulated result A+B+C+D+E+F+G+H.

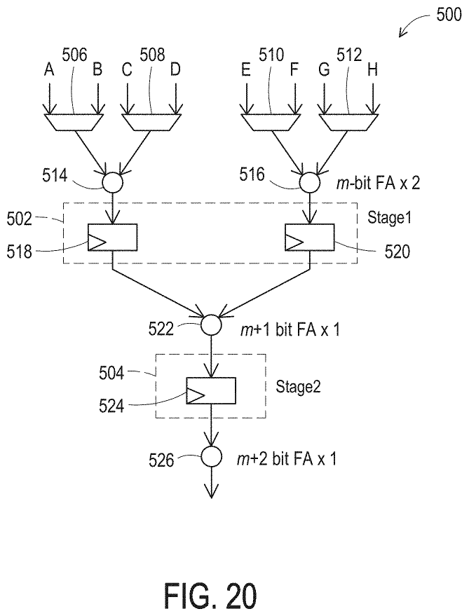

FIG. 20 is a diagram schematically illustrating an 8-input adder tree 500 that includes pipelining with MUXs and two register layers, including a first register layer 502 and a second register layer 504, in accordance with some embodiments. The adder tree 500 receives input signal sets A, B, C, D, E, F, G, and H, where each of the input signal sets A, B, C, D, E, F, G, and H includes m bits. The adder tree 500 provides pipelined summation results of the input signal sets A, B, C, D, E, F, G, and H, and pipelined accumulated results, such as A, A+B, A+B+C, A+B+C+D, and so on. In some embodiments, the adder tree 450 is like the adder tree 42 (shown in FIG. 1).

The adder tree 500 includes a first MUX 506, a second MUX 508, a third MUX 510, and a fourth MUX 512. Each of the first MUX 506 and the second MUX 508 has outputs electrically coupled to corresponding inputs of a first adder 514, and each of the third MUX 510 and the fourth MUX 512 has outputs electrically coupled to corresponding inputs of a second adder 516. The first MUX 506 has inputs that receive the input signal sets A and B, the second MUX 508 has inputs that receive the input signal sets C and D, the third MUX 510 has inputs that receive the input signal sets E and F, and the fourth MUX 512 has inputs that receive the input signal sets G and H. Multiplexing multiple inputs to the first and second adders 514 and 516, increases parallelism and reduces the number of adders in the adder tree 500, which reduces layout area and power consumption.

The first register layer 502 includes a first register 518 and a second register 520 disposed between the first and second adders 514 and 516 and a third adder 522. The first register 518 has inputs electrically coupled to corresponding outputs of the first adder 514, and outputs electrically coupled to corresponding inputs of the third adder 522. The second register 520 has inputs electrically coupled to corresponding outputs of the second adder 516, and outputs electrically coupled to corresponding inputs of the third adder 522. The first register 518 and the second register 520 enable parallel operation for computing and pipelining accumulated inputs.

The second register layer 504 includes a third register 524 that has inputs electrically coupled to corresponding outputs of the third adder 522, and outputs electrically coupled to corresponding inputs of an accumulator 526. The outputs of the third register 524 provide pipelined m+2 bit summation results, such as A, B, C, D, E, F, G, and H to the accumulator 526. The accumulator 526 provides accumulated results A, A+B, A+B+C, A+B+C+D, A+B+C+D+E, A+B+C+D+E+F, and A+B+C+D+E+F+G+H.

In some embodiments, the input signal set A is provided in a first clock cycle, i.e. clock cycle 0, the input signal set B is provided in a second clock cycle, i.e. clock cycle 1, the input signal set C is provided in a third clock cycle, i.e. clock cycle 2, the input signal set D is provided in a fourth clock cycle, i.e. clock cycle 3, the input signal set E is provided in a fifth clock cycle, i.e. clock cycle 4, the input signal set F is provided in a sixth clock cycle, i.e. clock cycle 5, the input signal set G is provided in a seventh clock cycle, i.e. clock cycle 6, and the input signal set H is provided in an eighth clock cycle, i.e. clock cycle 7.

The first adder 514 is an m bit FA configured to receive input signals of m bits from each of the first MUX 506 and the second MUX 508. The first adder 514 provides an m+1 bit summation result to the inputs of the first register 518. The second adder 516 is an m bit FA configured to receive input signals of m bits from each of the third MUX 510 and the fourth MUX 512. The second adder 516 provides an m+1 bit summation result to the inputs of the second register 520.

The first register 518 receives and stores the m+1 bit summation results from the first adder 514 and provides the stored m+1 bit summation results to the third adder 522. The second register 520 receives and stores the m+1 bit summation results from the second adder 516 and provides the stored m+1 bit summation results to the third adder 522. In some embodiments, the first and second registers 518 and 520 are clocked at the same time, i.e., simultaneously. In some embodiments, the first register 518 clocks in and stores the m+1 bit summation results from the first adder 514 in the second, third, fourth, and fifth clock cycles, i.e., clock cycles 1-4, and the second register 520 clocks in and stores the m+1 bit summation results from the second adder 516 in the sixth, seventh, eighth, and ninth clock cycles, i.e., clock cycles 5-8.

The third adder 522 is an m+1 bit FA configured to receive input signals of m+1 bits from each of the first register 518 and the second register 520. The third adder 522 provides an m+2 bit summation result to the third register 524.

The third register 524 receives and stores the m+2 bit summation result from the third adder 522 and provides the m+2 bit summation result to the accumulator 526, which is an m+2 bit accumulator 526. The accumulator 526 accumulates the results and provides accumulated results A, A+B, A+B+C, A+B+C+D, A+B+C+D+E, A+B+C+D+E+F, and A+B+C+D+E+F+G+H.

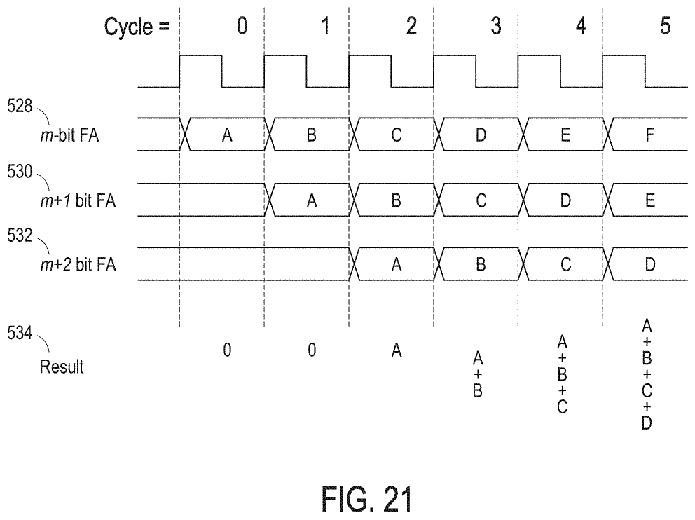

FIG. 21 is a timing diagram schematically illustrating operation of the adder tree 500, in accordance with some embodiments. The adder tree 500 receives clock signals for clocking the first register 518, the second register 520, and the third register 524. In some embodiments, the first register 518 and the second register 520 are clocked at the same time, i.e., simultaneously, by the clock signals. In some embodiments, the first register 518, the second register 520, and the third register 524 are clocked at the same time, i.e., simultaneously, by the clock signals. In some embodiments, the clock signals are provided by a clocking circuit like the clocking circuit 60 (shown in FIG. 1).

In operation, during clock cycle 0, the first MUX 506 receives input signal set A and provides it to the first adder 514. As indicated in row 528, the first adder 514 provides an m+1 bit summation result A to the first register 518.

During clock cycle 1, as indicated in row 530, the first register 518 clocks in and stores the m+1 bit summation result A from the first adder 514. The stored m+1 bit summation result A is provided to the third adder 522 that provides an m+2 bit summation result A to the third register 524 during clock cycle 1. Also, the first MUX 506 receives input signal set B and provides it to the first adder 514, which provides an m+1 bit summation result B to the first register 518.

As indicated in rows 532 and 534, during clock cycle 2, the third register 524 clocks in and stores the m+2 bit summation result A and provides the m+2 bit summation result A to the accumulator 526. The accumulator 526 provides an accumulated result A. As indicated in row 530, the first register 518 clocks in and stores the m+1 bit summation result B from the first adder 514. The stored m+1 bit summation result B is provided to the third adder 522 that provides an m+2 bit summation result B to the third register 524 during clock cycle 2. Also, the second MUX 508 receives input signal set C and provides it to the first adder 514, which provides an m+1 bit summation result C to the first register 468.

As indicated in rows 532 and 534, during clock cycle 3, the third register 524 clocks in and stores the m+2 bit summation result B and provides the m+2 bit summation result B to the accumulator 526. The accumulator 526 provides an accumulated result A+B. As indicated in row 530, the first register 518 clocks in and stores the m+1 bit summation result C from the first adder 514. The stored m+1 bit summation result C is provided to the third adder 522 that provides an m+2 bit summation result C to the third register 524 during clock cycle 3. Also, the second MUX 508 receives input signal set D and provides it to the first adder 514, which provides an m+1 bit summation result D to the first register 468.

As indicated in rows 532 and 534, during clock cycle 4, the third register 524 clocks in and stores the m+2 bit summation result C and provides the m+2 bit summation result C to the accumulator 526. The accumulator 526 provides an accumulated result A+B+C. As indicated in row 530, the first register 518 clocks in and stores the m+1 bit summation result D from the first adder 514. The stored m+1 bit summation result D is provided to the third adder 522 that provides an m+2 bit summation result D to the third register 524 during clock cycle 4. Also, the third MUX 510 receives input signal set E and provides it to the second adder 516, which provides an m+1 bit summation result E to the second register 520.

As indicated in rows 532 and 534, during clock cycle 5, the third register 524 clocks in and stores the m+2 bit summation result D and provides the m+2 bit summation result D to the accumulator 526. The accumulator 526 provides an accumulated result A+B+C+D. As indicated in row 530, the second register 520 clocks in and stores the m+1 bit summation result E from the second adder 516. The stored m+1 bit summation result E is provided to the third adder 522 that provides an m+2 bit summation result E to the third register 524 during clock cycle 5. Also, the third MUX 510 receives input signal set F and provides it to the second adder 516, which provides an m+1 bit summation result F to the second register 520.

During clock cycle 6 (not shown in FIG. 21), the third register 524 clocks in and stores the m+2 bit summation result E and provides the m+2 bit summation result E to the accumulator 526. The accumulator 526 provides an accumulated result A+B+C+D+E. The process continues as described above with the input signal sets F, G, and H, such that the accumulator 526 further provides accumulated results A+B+C+D+E+F, A+B+C+D+E+F+G, and A+B+C+D+E+F+G+H.

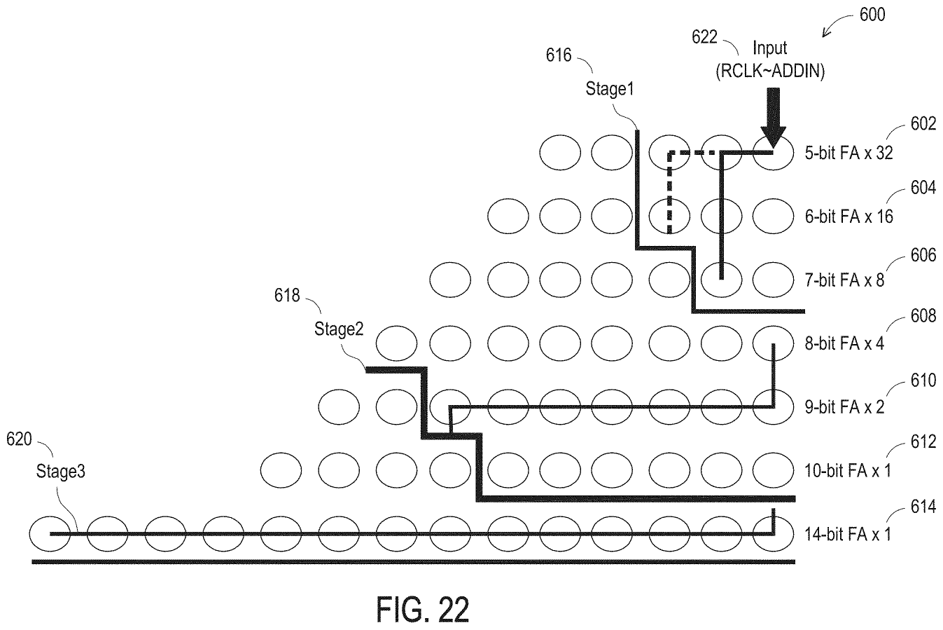

FIG. 22 is a diagram schematically illustrating an adder tree 600 with a stepwise pipeline architecture, in accordance with some embodiments. The adder tree 600 includes thirty-two 5-bit FAs 602, sixteen 6-bit FAs 604, eight 7-bit FAs 606, four 8-bit FAs 608, two 9-bit FAs 610, and one 10-bit FA 612. In some embodiments, the adder tree 600 further includes another FA that has more than 10-bits, such as one 14-bit FA 614 for further processing. In some embodiments, the adder tree 600 is like the adder tree 42 (shown in FIG. 1).

The adder tree 600 includes three register layers or stages including a stage 1 616, a stage 2 618, and a stage 3 620. The pipeline of stage 1 616 is a stepwise pipeline that includes at least some of the bits of the 7-bit FAs 606 and the 6-bit FAs 604. The pipeline of stage 2 618 is a stepwise pipeline that includes some of the bits of the 10-bit FAs 612, the 9-bit FAs 610, and the 8-bit FAs 608. The pipeline of stage 3 620 is a pipeline that includes the 14-bit FA 614.

At least some of the adders in the adder tree 600 are separated or divided into different pipeline stages, which leads to a complicated clock tree 622. However, the propagation delays between the three stages 616, 618, and 620 can be optimized. In some embodiments, 6 registers are provided per FA in stage 1 616. In some embodiments, 10 registers are provided per FA in stage 2 618. In some embodiments, 14 registers are provided per FA in stage 3 620.

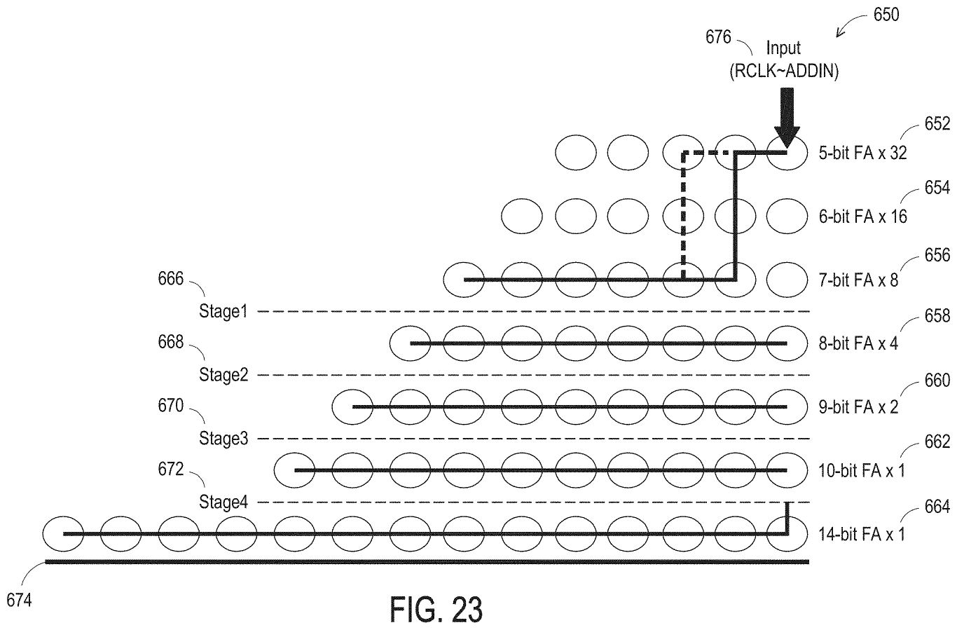

FIG. 23 is a diagram schematically illustrating an adder tree 650 including one or more plain pipelines, in accordance with some embodiments. The adder tree 650 includes thirty-two 5-bit FAs 652, sixteen 6-bit FAs 654, eight 7-bit FAs 656, four 8-bit FAs 658, two 9-bit FAs 660, and one 10-bit FA 662. In some embodiments, the adder tree 650 further includes another FA that has more than 10-bits, such as one 14-bit FA 664 for further processing. In some embodiments, the adder tree 650 is like the adder tree 42 (shown in FIG. 1).

The adder tree 650 includes one or more register layers or stages, such as a stage 1 666, a stage 2 668, a stage 3 670, and a stage 4 672. The pipeline of stage 1 666 is a plain pipeline that includes 7*8=56 registers after the 7-bit FAs 656. The pipeline of stage 2 668 is a plain pipeline that includes 8*4=32 registers after the 8-bit FAs 658. The pipeline of stage 3 670 is a plain pipeline that includes 9*2=18 registers after the 9-bit FAs 660. The pipeline of stage 4 672 is a plain pipeline that includes 10*1=10 registers after the 10-bit FAs 662. In some embodiments, the adder tree 650 further includes another FA that has more than 10-bits, such as one 14-bit FA 674 for further processing.

The adders in the adder tree 600 are not separated or divided into different pipeline stages, which leads to a simple clock tree 676. However, the propagation delay balancing may be difficult with the plain pipelines and delay overhead may become large.

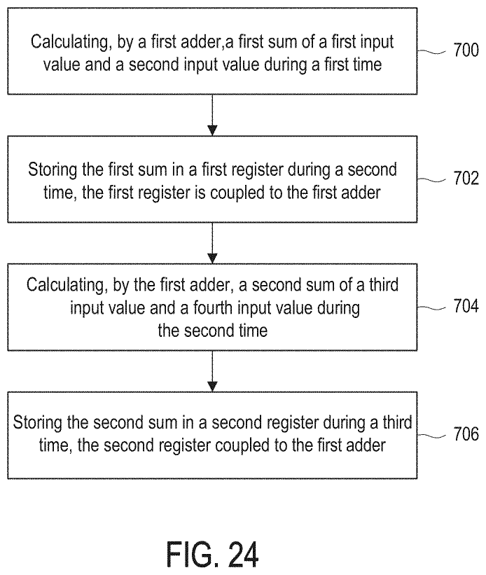

FIG. 24 is a diagram schematically illustrating a method of adding in an adder tree that includes one or more registers, in accordance with some embodiments. In some embodiments, the adder tree is one of the adder trees described herein, such as the adder tree 100 of FIG. 2, the adder tree 150 of FIG. 10, the adder tree 200 of FIG. 12, the adder tree 300 of FIG. 14, the adder tree 400 of FIG. 16, the adder tree 450 of FIG. 18, the adder tree 500 of FIG. 20, the adder tree 600 of FIG. 22, and the adder tree 650 of FIG. 23.

At step 700, the method includes calculating, by a first adder, such as the adder 106 (shown in FIGS. 2, 4, 6, and 8) a first sum of a first input value and a second input value during a first time. Next, at step 702, the method includes storing the first sum in a first register, such as register 108, during a second time, where the first register is coupled to the first adder. At step 704, the method includes calculating, by the first adder, such as the adder 106, a second sum of a third input value and a fourth input value during the second time and, at step 706, the method includes storing the second sum in a second register, such as register 110, during a third time, where the second register is coupled to the first adder. In some embodiments, the method further includes calculating, by a second adder, such as the adder 112, a third sum based on the first sum and/or the second sum.

In some embodiments, the method includes receiving at one or more MUXs, such as the first MUX 102 and the second MUX 104, the first input value, the second input value, the third input value, and the fourth input value, and providing, by the one or more MUXs, the first input value, the second input value, the third input value, and the fourth input value to the first adder, such as the adder 106.

Also, in some embodiments, the method includes receiving, at one or more MUXs, such as the fifth MUX 322 and/or the sixth MUX 324 (shown in FIG. 14), outputs of the first sum and the second sum from the first register and the second register, where the one or more MUXs are coupled to the first register and the second register. The method further includes providing, by the one or more MUXs, such as the fifth MUX 322 and/or the sixth MUX 324 (shown in FIG. 14), outputs of the first sum and the second sum to a second adder, such as adder 326, and calculating, by the second adder, a third sum based on the first sum or the second sum.

Disclosed embodiments thus provide adder trees that include registers in a pipeline architecture. The adder trees include one or more pipelines, such that the adder trees have fewer adders, which reduces power consumption and the amount of area taken up by an adder tree in an integrated circuit. The adder trees with one or more pipelines also realize higher parallelism and decrease delays by decreasing the number of gate levels and shortening critical paths in the adder tree.

In some embodiments, the adder tree includes multiple register layers or stages, such as a first layer with registers disposed between one or more m-bit FAs and one or more m+1-bit FAs, and a second layer with registers disposed between one or more m+1-bit FAs and one or more m+2-bit FAs. The registers in the first and second layers enable parallel operation for computing and pipelining accumulated inputs. In some embodiments, MUXs gate inputs to the one or more m-bit FAs. In some embodiments, MUXs gate outputs from the registers in the first layer to the one or more m+1-bit FAs. Multiplexing multiple inputs to the FAs increases parallelism and reduces the number of FAs, which reduces layout area and power consumption.

Also, disclosed embodiments include adder trees with stepwise pipelines that optimize balancing of propagation delays between stages and adder trees with plain pipelines that are simpler for placing the adders and the clock tree.

In accordance with some embodiments, a device includes a first adder, a second adder, a first register, and a second register. The first adder has first adder input terminals and first adder output terminals and is configured to receive a first input value, a second input value, a third input value, and a fourth input value at the first adder input terminals. The first register has first register input terminals and first register output terminals with the first register input terminals coupled to the first adder output terminals. The second register has second register input terminals and second register output terminals with the second register input terminals coupled to the first adder output terminals. The second adder has second adder input terminals and second adder output terminals with the second adder input terminals configured to receive register output signals from the first register output terminals and the second register output terminals. Wherein, the first adder is configured to calculate a first sum of the first input value and the second input value, and the first register is configured to store the first sum, and the first adder is configured to calculate a second sum of the third input value and the fourth input value, and the second register is configured to store the second sum.

In accordance with further embodiments, a device includes a clock circuit, first adder circuits, and first register circuits. The clock circuit is configured to provide clock signals. The first adder circuits are configured to receive input signals and provide a first sequence of adder sums based on the input signals, and each of the first register circuits is connected to an adder circuit of the first adder circuits to receive at least one adder sum of the first sequence of adder sums from the adder circuit. Wherein, the first register circuits are configured to be clocked in parallel by the clock signals to clock in the first sequence of adder sums.

In accordance with still further disclosed aspects, a method of adding in an adder tree includes: calculating, by a first adder, a first sum of a first input value and a second input value during a first time; storing the first sum in a first register during a second time, the first register coupled to the first adder; calculating, by the first adder, a second sum of a third input value and a fourth input value during the second time; and storing the second sum in a second register during a third time, the second register coupled to the first adder.

This disclosure outlines various embodiments so that those skilled in the art may better understand the aspects of the present disclosure. Those skilled in the art should appreciate that they may readily use the present disclosure as a basis for designing or modifying other processes and structures for carrying out the same purposes and/or achieving the same advantages of the embodiments introduced herein. Those skilled in the art should also realize that such equivalent constructions do not depart from the spirit and scope of the present disclosure, and that they may make various changes, substitutions, and alterations herein without departing from the spirit and scope of the present disclosure.

What is claimed is:

1. A device, comprising:
a first adder having first adder input terminals and first adder output terminals and configured to receive a first input value, a second input value, a third input value, and a fourth input value at the first adder input terminals;
a first register having first register input terminals and first register output terminals, the first register input terminals coupled to the first adder output terminals;
a second register having second register input terminals and second register output terminals, the second register input terminals coupled to the first adder output terminals; and
a second adder having second adder input terminals and second adder output terminals and configured to receive register output signals from the first register output terminals and the second register output terminals at the second adder input terminals,
wherein the first adder is configured to calculate a first sum of the first input value and the second input value and the first register is configured to store the first sum, and the first adder is configured to calculate a second sum of the third input value and the fourth input value and the second register is configured to store the second sum.

2. The device of claim 1, wherein the second adder is configured to calculate a third sum of the first sum and the second sum.

3. The device of claim 1, comprising multiplexers configured to provide the first input value, the second input value, the third input value, and the fourth input value to the first adder input terminals.

4. The device of claim 1, wherein the first adder is configured to calculate the first sum of the first input value and the second input value during a first time, and the first register is configured to store the first sum during a second time.

5. The device of claim 4, wherein the first adder is configured to calculate the second sum of the third input value and the fourth input value during the second time, and the second register is configured to store the second sum during a third time.

6. The device of claim 5, wherein the second adder is configured to calculate a third sum of the first sum and the second sum during the third time.

7. The device of claim 1, comprising a multiplexer coupled to the first register output terminals and to the second register output terminals and configured to provide the register output signals to the second adder input terminals.

8. The device of claim 1, comprising:
a third register having third register input terminals and third register output terminals, the third register output terminals coupled to the first adder input terminals; and
a fourth register having fourth register input terminals and fourth register output terminals, the fourth register output terminals coupled to the first adder input terminals.

9. The device of claim 8, comprising a third adder having third adder input terminals and third adder output terminals coupled to the third register input terminals, and a fourth adder having fourth adder input terminals and fourth adder output terminals coupled to the fourth register input terminals.

10. The device of claim 9, comprising multiplexers configured to provide input values to the third adder input terminals and to the fourth adder input terminals.

11. A device, comprising:
a clock circuit configured to provide clock signals;
first adder circuits configured to receive input signals and provide a first sequence of adder sums based on the input signals; and
first register circuits, each of the first register circuits connected to an adder circuit of the first adder circuits to receive at least one adder sum of the first sequence of adder sums from the adder circuit, wherein the first register circuits are configured to be clocked in parallel by the clock signals to clock in the first sequence of adder sums.

12. The device of claim 11, comprising multiplexers configured to receive multiplexer input signals and provide the input signals to the first adder circuits based on the multiplexer input signals.

13. The device of claim 11, comprising:
second adder circuits configured to receive the first sequence of adder sums from the first register circuits and provide a second sequence of adder sums based on the first sequence of adder sums; and
second register circuits, each of the second register circuits connected to an adder circuit of the second adder circuits to receive at least one adder sum of the second sequence of adder sums from the adder circuit of the second adder circuits, wherein the second register circuits are configured to be clocked in parallel by the clock signals to sequentially clock in the second sequence of adder sums.

14. The device of claim 13, comprising a third adder circuit configured to receive the second sequence of adder sums from the second register circuits and provide a third sequence of adder sums.

15. The device of claim 11, wherein the clock circuit is configured to clock registers at different adder tree levels in parallel.

16. The device of claim 11, wherein the clock circuit is configured to clock registers at the same adder tree level in parallel.

17. A method of adding in an adder tree comprising:
calculating, by a first adder, a first sum of a first input value and a second input value during a first time;
storing the first sum in a first register during a second time, the first register coupled to the first adder;
calculating, by the first adder, a second sum of a third input value and a fourth input value during the second time; and
storing the second sum in a second register during a third time, the second register coupled to the first adder.

18. The method of claim 17, comprising calculating, by a second adder, a third sum based on the first sum and/or the second sum.

19. The method of claim 17, comprising:
receiving at one or more multiplexers the first input value, the second input value, the third input value, and the fourth input value; and
providing, by the one or more multiplexers, the first input value, the second input value, the third input value, and the fourth input value to the first adder.

20. The method of claim 17, comprising:
receiving, at one or more multiplexers, outputs of the first sum and the second sum from the first register and the second register, the one or more multiplexers coupled to the first register and the second register;
providing, by the one or more multiplexers, multiplexer outputs of the first sum and the second sum to a second adder; and
calculating, by the second adder, a third sum based on the first sum or the second sum.
